(19) United States
(12) Patent Application Publication
(10) Pub. No.: US 2026/0267049 A1
(43) Pub. Date: Sep. 10, 2026

(54) OPTICAL LAMINATE

(71) Applicant: FUJIFILM Corporation, Tokyo (JP)

(72) Inventors: Takehiko HARASAWA, Minamiashigara-shi (JP); Satoshi NAGANO, Minamiashigara-shi (JP)

(73) Assignee: FUJIFILM Corporation, Tokyo (JP)

(21) Appl. No.: 19/665,043

(22) Filed: May 1, 2026

Related U.S. Application Data
(63) Continuation of application No. PCT/JP2024/040469, filed on Nov. 14, 2024.

(30) Foreign Application Priority Data
Nov. 21, 2023 (JP) 2023-197096

(51) Int. Cl. G02B 5/30

(52) U.S. Cl. CPC G02B 5/3016

(57) ABSTRACT

An optical laminate is provided that suppresses peeling of an optical functional layer from a support due to contraction. The laminate includes a support having a thermal expansion coefficient of less than 1×10⁻⁵/° C. and an optical functional layer formed of a liquid crystal composition with an in-plane rotating optical axis alignment pattern. Edge surfaces of the support and the optical functional layer are flush. An edge surface covering layer is provided to cover a region corresponding to an interface between the support and the optical functional layer on the edge surface. When viewed perpendicular to a main surface, the covering layer extends along each side from corner portions over at least 10% of a side length, thereby improving adhesion and durability.

### CROSS-REFERENCE TO RELATED APPLICATIONS

This application is a Continuation of PCT International Application No. PCT/JP2024/040469 filed on Nov. 14, 2024, which claims priority under 35 U.S.C. § 119(a) to Japanese Patent Application No. 2023-197096 filed on Nov. 21, 2023. The above applications are hereby expressly incorporated by reference, in their entirety, into the present application.

### BACKGROUND OF THE INVENTION

### 1. Field of the Invention

The present invention relates to an optical laminate.

### 2. Description of the Related Art

As an optical member having a function of a diffraction element, a lens, or the like, an optical laminate including an optical functional layer formed of a liquid crystal material has been proposed.

The optical functional layer formed of a liquid crystal material exhibits a desired function by aligning a liquid crystal compound in a predetermined alignment pattern. In order to align the liquid crystal compound in the optical functional layer in a predetermined orientation state, the optical functional layer is formed by applying a liquid crystal composition including the liquid crystal compound onto an alignment film having an orientation function and curing the liquid crystal composition.

For example, WO2020/022513A discloses a method of manufacturing an optical element including an optically anisotropic layer formed of a liquid crystal composition containing a liquid crystal compound, an alignment film on which the liquid crystal compound is aligned, and a support, the method including an alignment film forming step of forming the alignment film on one surface of the support and an optically anisotropic layer forming step of forming the optically anisotropic layer on the alignment film, in which the alignment film contains a photo-alignment material, the alignment film forming step includes an exposure step of exposing different light in a polarization direction to different in-plane positions of the alignment film, and the support scatters light in a wavelength range of at least a part of a light absorption band in which a photochemical reaction of the alignment film occurs by irradiating the alignment film with polarized light in the exposure step.

### SUMMARY OF THE INVENTION

From the viewpoint of improving productivity in a case of manufacturing the optical functional layer formed of the liquid crystal compound as described above, the present inventors have studied to manufacture a plurality of optical laminates including the optical functional layer by forming a plurality of regions having a predetermined liquid crystal alignment pattern in a liquid crystal layer applied onto a support (alignment film), and cutting out each region including the liquid crystal alignment pattern.

However, it was found that, in a case where the optical functional layer is cut out together with the support, a problem occurs in that a corner portion of the optical functional layer is peeled off from the support due to contraction of the optical functional layer.

An object of the present invention is to solve the above-described problem of the related art, and to provide an optical laminate capable of preventing a corner portion of an optical functional layer from being peeled off from a support due to contraction of the optical functional layer.

In order to achieve this object, the present invention has the following configurations.

[1] An optical laminate comprising: a first laminate including a support and an optical functional layer that is laminated on the support and is formed of a liquid crystal composition containing a liquid crystal compound,
in which a thermal expansion coefficient of the support is less than 1×10⁻⁵/° C.,
the optical functional layer has a liquid crystal alignment pattern in which an orientation of an optical axis derived from the liquid crystal compound changes while the orientation continuously rotates along at least one in-plane direction,
an edge surface of the support and an edge surface of the optical functional layer in the first laminate are flush with each other,
the optical laminate has an edge surface covering layer that covers a region corresponding to an interface between the support and the optical functional layer on the edge surface of the first laminate, and
when viewed from a direction perpendicular to a main surface of the first laminate, the edge surface covering layer covers a portion corresponding to 10% or more of a length of each side from each corner portion of the main surface of the first laminate.

[2] The optical laminate according to [1], in which when viewed from the direction perpendicular to the main surface of the first laminate, the edge surface covering layer covers a portion corresponding to 50% or more of a length of each side of the main surface of the first laminate.

[3] The optical laminate according to [1] or [2], in which the edge surface covering layer is an organic material, and a thickness of the edge surface covering layer in a direction perpendicular to the edge surface of the first laminate is 1 μm to 1 mm.

[4] The optical laminate according to [1] or [2], in which the edge surface covering layer is an inorganic material, and a thickness of the edge surface covering layer in a direction perpendicular to the edge surface of the first laminate is 10 nm to 500 nm.

[5] The optical laminate according to [1], in which the edge surface covering layer covers the edge surface from a part of at least one main surface of the first laminate.

[6] The optical laminate according to [5], in which the edge surface covering layer covers the edge surface from a part of the main surface of the first laminate on an optical functional layer side.

[7] The optical laminate according to [5], in which the edge surface covering layer covers the edge surface from a part of main surfaces of the first laminate on both sides.

[8] The optical laminate according to any one of [5] to [7], in which a width of a ramp portion of the edge surface covering layer, which is formed on the main surface of the first laminate, from the edge surface is 0.01 mm or more.

[9] The optical laminate according to any one of [5] to [7], in which the edge surface covering layer is an organic material, and a height of a ramp portion formed on the main surface of the first laminate, in a direction perpendicular to the main surface is 1 μm to 1 mm.

[10] The optical laminate according to any one of [5] to [7], in which the edge surface covering layer is an inorganic material, and a height of a ramp portion, which is formed on the main surface of the first laminate, in a direction perpendicular to the main surface is 10 nm to 500 nm.

[11] The optical laminate according to [1] or [2], in which a peeling strength of the edge surface covering layer with respect to the support and the optical functional layer is 4 N/cm or more.

[12] The optical laminate according to [1] or [2], in which a material of the support includes any one of glass, quartz, or silicon.

[13] The optical laminate according to [1] or [2], in which the edge surface covering layer is an organic material, and includes any one of an acrylic resin, an epoxy resin, or a silicone resin.

[14] The optical laminate according to [1] or [2], in which the edge surface covering layer is an organic material, and includes a light absorbing material.

[15] The optical laminate according to [1] or [2], in which the optical functional layer is formed of a liquid crystal composition containing a polymerizable liquid crystal compound, and is a cured film obtained by polymerizing the polymerizable liquid crystal compound.

[16] The optical laminate according to [1] or [2], in which the first laminate is obtained by cutting.

According to the present invention, it is possible to provide an optical laminate capable of preventing a corner portion of an optical functional layer from being peeled off from a support due to contraction of the optical functional layer.

### BRIEF DESCRIPTION OF THE DRAWINGS

FIG. 1 is a front view conceptually showing an example of an optical laminate according to the present invention.

FIG. 2 is a cross-sectional view taken along line A-A of the optical laminate shown in FIG. 1.

FIG. 3 is a cross-sectional view conceptually showing another example of the optical laminate according to the present invention.

FIG. 4 is a cross-sectional view conceptually showing still another example of the optical laminate according to the present invention.

FIG. 5 is a conceptual view for describing an example of an optical functional layer included in the optical laminate according to the present invention.

FIG. 6 is a partial cross-sectional view of the optical laminate shown in FIG. 5.

FIG. 7 is a conceptual view for describing the optical functional layer.

FIG. 8 is a cross-sectional view conceptually showing still another example of the optical functional layer.

FIG. 9 is a conceptual view for describing a manufacturing method of the optical laminate according to the present invention.

FIG. 10 is a view conceptually showing an example of an exposure device that exposes an alignment film for forming the optical functional layer.

FIG. 11 is a view conceptually showing still another example of the exposure device that exposes the alignment film for forming the optical functional layer.

### DESCRIPTION OF THE PREFERRED EMBODIMENTS

Hereinafter, the optical laminate according to the embodiment of the present invention will be described in detail based on suitable examples shown in the accompanying drawings.

Each of the drawings shown below is a conceptual view for describing the present invention, and the shape, size (size ratio), positional relationship, and the like of each of the components are different from the actual ones.

In addition, in the present invention, a numerical range expressed using “to” means a range including numerical values indicated before and after “to” as a lower limit value and an upper limit value.

### [Optical Laminate]

An optical laminate according to the embodiment of the present invention includes:
a first laminate including a support and an optical functional layer that is laminated on the support and is formed of a liquid crystal composition containing a liquid crystal compound, in which
a thermal expansion coefficient of the support is less than 1×10⁻⁵/° C.,
the optical functional layer has a liquid crystal alignment pattern in which an orientation of an optical axis derived from the liquid crystal compound changes while the orientation continuously rotates along at least one in-plane direction,
an edge surface of the support and an edge surface of the optical functional layer in the first laminate are flush with each other,
the optical laminate has an edge surface covering layer that covers a region corresponding to an interface between the support and the optical functional layer on the edge surface of the first laminate, and
when viewed from a direction perpendicular to a main surface of the first laminate, the edge surface covering layer covers a portion corresponding to 10% or more of a length of each side from each corner portion of the main surface of the first laminate.

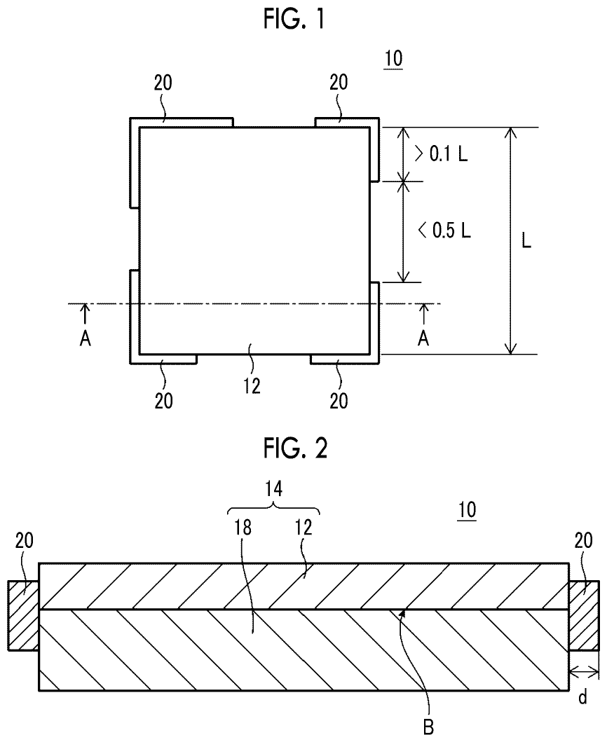

FIG. 1 is a front view conceptually showing an example of the optical laminate according to the embodiment of the present invention. In addition, FIG. 2 is a cross-sectional view taken along line A-A of the optical laminate shown in FIG. 1.

An optical laminate 10 shown in FIGS. 1 and 2 includes a first laminate 14 including a support 18 and an optical functional layer 12, and an edge surface covering layer 20 that covers a part of an edge surface of the first laminate 14.

As will be described later, the first laminate 14 is preferably formed by cutting out a region corresponding to one optical functional layer from a laminate in which a liquid crystal layer in which a plurality of regions (regions having a liquid crystal alignment pattern) serving as the optical functional layer are formed is laminated on the support. Therefore, in the first laminate 14, the edge surface of the support 18 and the edge surface of the optical functional layer 12 are flush with each other. The edge surface covering layer 20 is formed on the edge surfaces of the support 18 and the optical functional layer 12, which are formed to be flush with each other.

In the present invention, the fact that the edge surface of the support 18 and the edge surface of the optical functional layer 12 are flush with each other means that a level difference between the edge surface of the support 18 and the edge surface of the optical functional layer 12 is less than 1 mm. The level difference between the edge surface of the support 18 and the edge surface of the optical functional layer 12 is preferably less than 1 mm, more preferably 0.1 mm or less, and still more preferably 0.0005 mm or less. In a case where the level difference between the edge surface of the support 18 and the edge surface of the optical functional layer 12 is less than 1 mm, it is possible to suppress the peeling of the optical functional layer 12 before the edge surface covering layer 20 is formed.

As shown in FIG. 2, the edge surface covering layer 20 covers at least a position of an interface B between the support 18 and the optical functional layer 12 of the edge surface of the first laminate 14. That is, the edge surface covering layer 20 is formed in a region of the edge surface of the first laminate 14, which includes the position of the interface B between the support 18 and the optical functional layer 12, in the thickness direction.

In addition, as shown in FIG. 1, the first laminate 14 has a rectangular shape when viewed from a direction perpendicular to the main surface, and the edge surface covering layer 20 is formed in each of regions including corner portions of the main surface. In other words, the edge surface covering layer 20 is formed in a region having a predetermined length from an end part of each side of the first laminate 14 when viewed from a direction perpendicular to the main surface. The main surface is a maximum surface of a sheet-like material, and is a surface perpendicular to a lamination direction of the support 18 and the optical functional layer 12 in the first laminate 14.

Here, in the present invention, the edge surface covering layer 20 covers a range of 10% or more of the length of each side from each corner portion of the main surface of the first laminate 14 on each side of the main surface of the first laminate 14. That is, as shown in FIG. 1, when viewed from a direction perpendicular to the main surface of the first laminate 14, the edge surface covering layer 20 is provided at each of two positions of both end parts of each side of the main surface of the first laminate 14, and the length thereof is 10% or more (0.1 L or more) of the length L of the side. The length of the edge surface covering layer 20 is a length at the position of the interface B between the support 18 and the optical functional layer 12.

As described above, from the viewpoint of improving the productivity in a case of producing the optical functional layer formed of the liquid crystal compound, the present inventors have studied to produce a plurality of optical laminates having the optical functional layer by forming a plurality of regions having a predetermined liquid crystal alignment pattern in the liquid crystal layer applied onto the support (alignment film), and cutting out the region including each liquid crystal alignment pattern.

However, it was found that, in the optical laminate in which the optical functional layer is cut out together with the support, the optical functional layer contracts due to a change in temperature and humidity of an atmospheric environment over time, and the like, and thus a problem occurs in that the corner portion of the optical functional layer is peeled off from the support. In particular, in a case where a support having a small thermal expansion coefficient is used, a difference in thermal expansion coefficient between the support and the optical functional layer is large, and thus such a problem is likely to occur.

In addition, according to the studies of the present inventors, it was found that, in a case where the optical functional layer has the liquid crystal alignment pattern in which the optical axis of the liquid crystal compound changes while continuously rotating in the one in-plane direction, the problem of peeling off the corner portion of the optical functional layer from the support is likely to occur. For example, in a case of the optical functional layer (liquid crystal layer) in which the optical axis of the liquid crystal compound is aligned in a predetermined one direction as used as the retardation layer, the optical functional layer has anisotropy in a shrinkage ratio in which the optical functional layer is less likely to shrink in a direction of the optical axis and is likely to shrink in a direction orthogonal to the optical axis. Specifically, for example, in a case of a rod-like liquid crystal compound, a major axis direction is the optical axis, and in a case where the optical axis of the liquid crystal compound is aligned in a predetermined one direction, the rod-like liquid crystal compounds are arranged in the major axis direction. Therefore, in this direction, a force against the internal shrinkage stress is generated, and thus the optical functional layer is less likely to shrink. In this case, the problem of peeling off the corner portion of the optical functional layer from the support is less likely to occur. On the other hand, in a case of the optical functional layer having the liquid crystal alignment pattern in which the optical axis of the liquid crystal compound changes while continuously rotating in the one in-plane direction, the optical functional layer is isotropically shrunk in a case where the optical functional layer is observed macroscopically. In a case where the optical functional layer is isotropically shrunk, it is considered that stress is concentrated on the corner portion of the optical functional layer, and thus the problem of peeling off the corner portion of the optical functional layer from the support is likely to occur.

On the other hand, the optical laminate according to the embodiment of the present invention has a configuration in which the optical laminate includes the edge surface covering layer 20 that covers a position of the interface B between the support 18 and the optical functional layer 12 on the edge surface of the first laminate 14 including the support 18 and the optical functional layer 12, and when viewed from a direction perpendicular to the main surface of the first laminate 14, the edge surface covering layer 20 covers a range of 10% or more of a length of each side from each corner portion of the main surface of the first laminate 14. As a result, it is possible to suppress the corner portion of the optical functional layer from peeling off from the support.

Here, from the viewpoint of suppressing the peeling of the optical functional layer, when viewed from a direction perpendicular to the main surface of the first laminate 14, a length of the edge surface covering layer 20 from each corner portion of the main surface of the first laminate 14 is preferably 10% or more of a length L of each side, more preferably 35% or more, and most preferably a length that covers the entire region of each side.

In a case of being viewed from a direction perpendicular to the main surface of the first laminate 14, the lengths of the edge surface covering layer 20 from each corner portion on a certain side of the main surface of the first laminate 14 may be the same as or different from each other.

In addition, when viewed from a direction perpendicular to the main surface of the first laminate 14, the length of the edge surface covering layer 20 from the corner portion on a certain side of the main surface of the first laminate 14 and the length of the edge surface covering layer 20 from the corner portion on the other side may be the same as or different from each other.

In addition, when viewed from a direction perpendicular to the main surface of the first laminate 14, on each side of the main surface of the first laminate 14, a total length of the edge surface covering layer 20 with respect to the length L of each side is preferably 50% or more of the length of each side, more preferably 80% or more, and most preferably a length that covers the entire region of each side. That is, on each side of the main surface of the first laminate 14, a length of a region not covered with the edge surface covering layer 20 is preferably less than 50% of the length L of each side (less than 0.5 L (see FIG. 1)).

In the example shown in FIG. 1, the edge surface covering layer 20 is formed at both end portions of each side of the main surface of the first laminate 14 when viewed from a direction perpendicular to the main surface of the first laminate 14, but the present invention is not limited to this, and the edge surface covering layer 20 may be formed in a region between the both end portions of each side in addition to the both end portions of each side. In this case, the total length of the edge surface covering layer 20 formed at both end portions and the edge surface covering layer 20 formed in the middle may be 50% or more of the length of the side.

In addition, in the example shown in FIG. 1, the shape of the first laminate 14 is a rectangular shape when viewed from a direction perpendicular to the main surface of the first laminate 14, but the present invention is not limited to this, and the shape of the first laminate 14 may be a polygonal shape such as a triangular shape or a pentagonal shape as long as the shape has a corner portion.

In addition, in the example shown in FIG. 1, the edge surface covering layer 20 is formed on all sides of the main surface of the first laminate 14 when viewed from a direction perpendicular to the main surface of the first laminate 14, but the present invention is not limited to this, and the edge surface covering layer 20 may be formed on at least one side of the main surface of the first laminate 14. From the viewpoint of suppressing peeling of the optical functional layer, it is preferable that the edge surface covering layer 20 is formed on all sides of the main surface of the first laminate 14.

In addition, a thickness d (see FIG. 2) of the edge surface covering layer 20 in a direction perpendicular to the edge surface of the first laminate 14 may be appropriately set depending on a material for forming the edge surface covering layer 20. In a case where the material for forming the edge surface covering layer 20 is an organic material, the thickness d of the edge surface covering layer 20 is preferably 1 μm to 1 mm, more preferably 1 μm to 100 μm, and still more preferably 1 μm to 20 μm. In addition, in a case where the material for forming the edge surface covering layer 20 is an inorganic material, the thickness d of the edge surface covering layer 20 is preferably 10 nm to 500 nm, more preferably 10 nm to 200 nm, and still more preferably 10 nm to 100 nm. In a case where the thickness d of the edge surface covering layer 20 is set to be in the above-described range, it is possible to more suitably suppress peeling of the corner portion of the optical functional layer 12 from the support 18. The material for forming the edge surface covering layer will be described in detail later.

In addition, a peeling strength of the edge surface covering layer 20 with respect to the support 18 and the optical functional layer 12 is preferably 4 N/cm or more, and more preferably 8 N/cm or more. In a case where the peeling strength of the edge surface covering layer 20 with respect to the support 18 and the optical functional layer 12 is set to be 4 N/cm or more, it is possible to more suitably suppress peeling of the corner portion of the optical functional layer 12 from the support 18.

Here, the peeling strength of the edge surface covering layer 20 with respect to the support 18 and the optical functional layer 12 can be evaluated by whether or not the edge surface covering layer is reflected on the pressure-sensitive adhesive tape in a case where a pressure-sensitive adhesive tape having a peeling strength of 4 N/cm is attached to the edge surface covering layer and the pressure-sensitive adhesive tape is pulled in a direction of 90° with a peeling tester. In addition, the peeling strength between the edge surface covering layer 20 and the support 18 and the optical functional layer 12 can be measured by performing the same test using a plurality of pressure-sensitive adhesive tapes having different peeling strengths. In addition, the peeling strength can be measured by performing a 90° peeling test using, for example, a jig capable of sandwiching the thin edge surface covering layer 20 and a tensile tester AGS-X manufactured by Shimadzu Corporation, in accordance with a general 90° peeling test method of JIS Z 0237.

In addition, in the example shown in FIG. 2, the edge surface covering layer 20 is configured to cover a part of the first laminate 14 in the thickness direction, the part including the position of the interface B between the support 18 and the optical functional layer 12 (hereinafter, also simply referred to as the position of the interface B), but the present invention is not limited thereto.

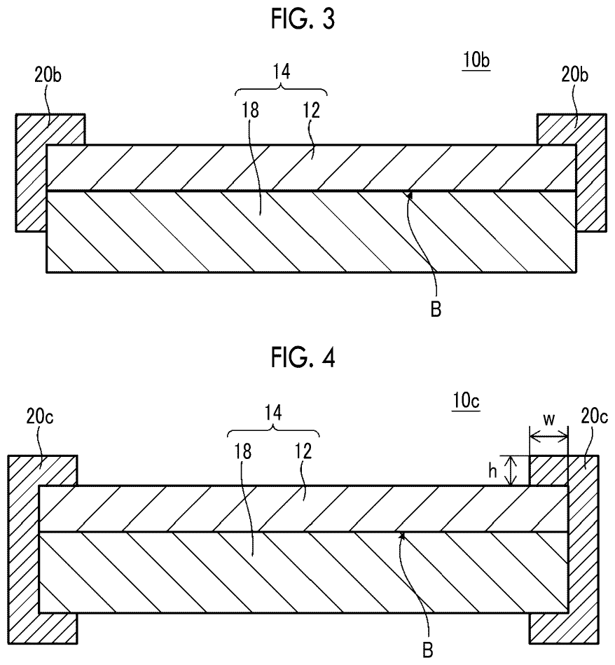

As in an optical laminate 10b shown in FIG. 3, an edge surface covering layer 20b may be configured to cover from a part of one main surface of the first laminate 14 to the edge surface. In the example shown in FIG. 6, in the optical laminate 10b, the edge surface covering layer 20b is formed from a part of the main surface of the first laminate 14 on the optical functional layer 12 side to a region of the edge surface including the position of the interface B.

Alternatively, as in an optical laminate 10c shown in FIG. 4, an edge surface covering layer 20c may be configured to cover from a part of the main surfaces on both sides of the first laminate 14 to the edge surface. That is, as shown in FIG. 4, the edge surface covering layer 20c is formed from a part of the main surface of the first laminate 14 on the optical functional layer 12 side to the entire region of the edge surface in the thickness direction, and further to a part of the main surface of the first laminate 14 on the support 18 side.

In this way, by configuring the edge surface covering layer to be formed on a part of at least one main surface of the first laminate 14, the corner portion of the optical functional layer 12 can be more suitably suppressed from being peeled off from the support 18.

As shown in FIGS. 3 and 4, in a case where the edge surface covering layer is formed on a part of at least one main surface of the first laminate 14, in a case where a portion of the edge surface covering layer formed on the main surface of the first laminate 14 is defined as a ramp portion, a width w (see FIG. 4) of the ramp portion from the edge surface of the first laminate 14 is preferably 0.01 mm or more, more preferably 0.01 mm to 1 mm, and still more preferably 0.05 mm to 0.3 mm. By setting the width w of the ramp portion to 0.01 mm or more, the corner portion of the optical functional layer 12 can be more suitably suppressed from being peeled off from the support 18.

In addition, a height h (see FIG. 4) of the ramp portion of the edge surface covering layer from the main surface of the first laminate 14 may be appropriately set according to the material for forming the edge surface covering layer. In a case where the material for forming the edge surface covering layer is an organic material, the height h of the ramp portion is preferably 1 μm to 1 mm, more preferably 1 μm to 100 μm, and still more preferably 1 μm to 20 μm. In addition, in a case where the material for forming the edge surface covering layer is an inorganic material, the height h of the ramp portion is preferably 10 nm to 500 nm, more preferably 10 nm to 200 nm, and still more preferably 10 nm to 100 nm.

Hereinafter, the constituent elements of the optical laminate will be described.

### [First Laminate]

The first laminate 14 includes a support 18 and an optical functional layer 12 laminated on the support 18. In the first laminate 14, the support 18 may include a substrate and an alignment film, and the optical functional layer 12 may be formed directly on the alignment film, or the optical functional layer 12 may be formed on another temporary support and then transferred to the substrate. In a case where the optical functional layer 12 is transferred to the substrate to form the first laminate 14, it is preferable that the optical functional layer 12 is laminated on the substrate through an adhesive layer. In this case, a laminate of the substrate and the adhesive layer corresponds to the support 18. The optical functional layer 12 is required to have smoothness in order to obtain appropriate optical performance. Therefore, in a case where the optical functional layer is transferred to the substrate using an adhesive layer, it is desirable to use a thin adhesive layer having a thickness of 10 μm or less. However, in a case where a thin adhesive layer is used, it is difficult to enhance the adhesiveness between the substrate and the optical functional layer, and thus a problem of peeling of the optical functional layer from a corner portion occurs.

### <Support>

The support 18 is a member for supporting the optical functional layer 12. The support 18 may consist of a substrate such as a glass substrate or a resin substrate alone, or may have a configuration in which an alignment film is laminated on such a substrate. Alternatively, the support 18 may have a configuration in which a substrate and an adhesive layer are laminated.

### (Substrate)

The substrate preferably has a transmittance of 50% or more, more preferably 70% or more, and still more preferably 85% or more with respect to light having a wavelength at which the optical functional layer acts.

The thickness of the substrate is not limited, and may be appropriately set depending on the use of the optical laminate, the material for forming the substrate, and the like, as long as the optical functional layer 12 can be supported. The thickness of the substrate is preferably 1 to 1,000 μm, more preferably 3 to 250 μm, and still more preferably 5 to 150 μm.

The substrate may be a single layer or a multilayer. In a case of being a single layer, the substrate may be a substrate consisting of glass, quartz, silicon, or the like, or may be a substrate consisting of a resin substrate consisting of triacetyl cellulose (TAC), polyethylene terephthalate (PET), polycarbonate, polyvinyl chloride, acrylic, polyolefin, or the like. Examples of the substrate in a case of being a multilayer include a substrate including any of the above-described single-layer substrates as a substrate and having another layer provided on a surface of the substrate. From the viewpoint of a small thermal expansion coefficient, the present application is suitably applied to a case where a substrate consisting of glass, quartz, silicon, or the like is used. As described below, in order to form the optical functional layer having a liquid crystal alignment pattern, it is necessary to irradiate the alignment film with laser light to form an alignment pattern. In this case, there is a concern that the temperature of the substrate may increase due to the irradiated laser light, but by using a substrate having a small thermal expansion coefficient, it is possible to prevent deformation of the alignment pattern caused by deformation of the substrate.

### (Alignment Film)

The alignment film is an alignment film for aligning the liquid crystal compound to a predetermined liquid crystal alignment pattern in a case of forming the optical functional layer 12.

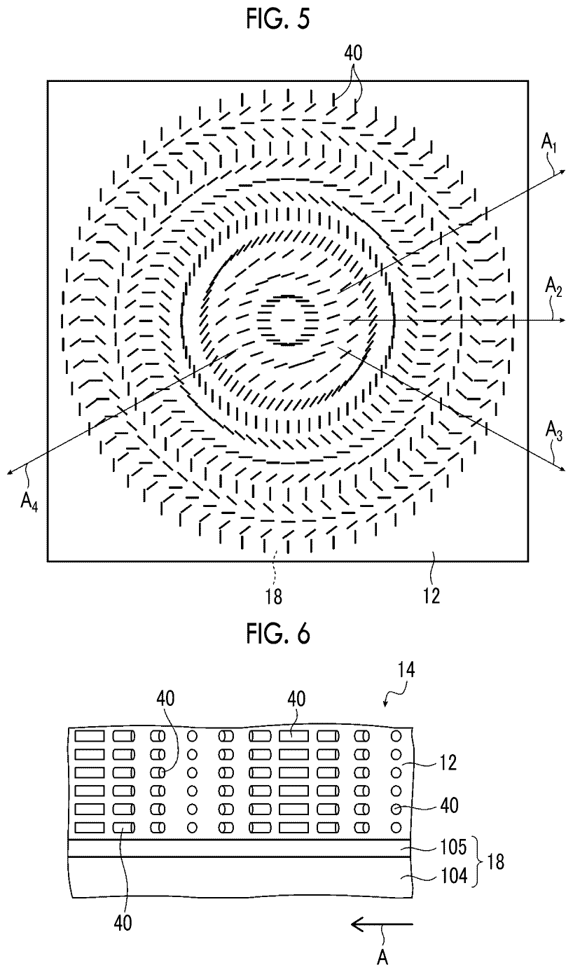

As described below, in the present invention, the optical functional layer 12 has a liquid crystal alignment pattern in which an orientation of an optical axis derived from the liquid crystal compound changes while continuously rotating in one in-plane direction (see FIG. 5). Accordingly, the alignment film is formed such that the optical functional layer 12 can form the liquid crystal alignment pattern.

As the alignment film, various known films can be used. Examples of the alignment film include a rubbing treatment film consisting of an organic compound such as a polymer, an oblique vapor-deposited film of an inorganic compound, a film having a microgroove, and a film obtained by accumulating a Langmuir-Blodgett (LB) film of an organic compound such as @-tricosanoic acid, methyldioctadecylammonium chloride, and methyl stearate using the Langmuir-Blodgett method.

The alignment film formed by a rubbing treatment can be formed by rubbing a surface of a polymer layer with paper or fabric in a predetermined direction multiple times. As the material used for the alignment film, for example, a material for forming polyimide, polyvinyl alcohol, a polymer having a polymerizable group described in JP1997-152509A (JP-H9-152509A), or an alignment film described in JP2005-097377A, JP2005-099228A, and JP2005-128503A is preferable.

The alignment film can be suitably used as a so-called photo-alignment film obtained by irradiating a photo-alignment material with polarized light or non-polarized light. That is, as the alignment film, a photo-alignment film formed by applying a photo-alignment material onto a substrate is suitably used. The irradiation of polarized light can be performed in a direction orthogonal or oblique to the photo-alignment film, and the irradiation of non-polarized light can be performed in an oblique direction with respect to the photo-alignment film.

Preferable examples of the photo-alignment material used in the alignment film that can be used in the present invention include: an azo compound described in JP2006-285197A, JP2007-076839A, JP2007-138138A, JP2007-094071A, JP2007-121721A, JP2007-140465A, JP2007-156439A, JP2007-133184A, JP2009-109831A, JP3883848B, and JP4151746B; an aromatic ester compound described in JP2002-229039A; a maleimide- and/or alkenyl-substituted nadiimide compound having a photo-alignable unit described in JP2002-265541A and JP2002-317013A; a photocrosslinking silane derivative described in JP4205195B and JP4205198B, a photocrosslinking polyimide, a photocrosslinking polyamide, or a photocrosslinking polyester described in JP2003-520878A, JP2004-529220A, and JP4162850B; and a photodimerizable compound, in particular, a cinnamate compound, a chalcone compound, or a coumarin compound described in JP1997-118717A (JP-H9-118717A), JP1998-506420A (JP-H10-506420A), JP2003-505561A, WO2010/150748A, JP2013-177561A, and JP2014-012823A. Among these, an azo compound, a photo-crosslinkable polyimide, a photo-crosslinkable polyamide, a photo-crosslinkable polyester, a cinnamate compound, or a chalcone compound is suitably used.

A thickness of the alignment film is not limited, and a thickness with which a required orientation function can be obtained may be appropriately set depending on the material for forming the alignment film. The thickness of the alignment film is preferably 0.01 to 5 μm and more preferably 0.05 to 2 μm.

A method for forming the alignment film is not limited. Various well-known methods corresponding to the material forming the alignment film can be used. Examples thereof include a method including: applying an alignment film to a surface of the support, drying the applied alignment film, and exposing the alignment film to laser light to form an alignment pattern. The method of forming the alignment film will be described in detail below.

### (Adhesive Layer)

The adhesive layer is a layer for bonding the optical functional layer 12 to the substrate.

As the adhesive layer, a layer consisting of various known materials can be used as long as the optical functional layer 12 and the substrate can be bonded to each other. The bonding layer may be a layer formed of an adhesive that has fluidity during bonding and is converted to a solid after bonding, a layer formed of a pressure sensitive adhesive that is a gel-like (rubber-like) flexible solid during bonding and of which the gel state does not change after bonding, or a layer formed of a material having characteristics of both the adhesive and the pressure sensitive adhesive. Accordingly, the bonding layer may be any well-known layer that is used for bonding a sheet-shaped material in an optical device or an optical element, for example, an optical clear adhesive (OCA), an optically transparent double-sided tape, or an ultraviolet curable resin.

Here, in the present invention, the support 18 has a thermal expansion coefficient of less than 1×10⁻⁵/° C.

As described above, in order to form the optical functional layer having the liquid crystal alignment pattern, it is necessary to irradiate the alignment film with laser light to form the alignment pattern. In this case, there is a concern that the temperature of the substrate may rise due to the irradiated laser light, but by using a substrate (support 18) having a small thermal expansion coefficient, it is possible to prevent deformation of the alignment pattern caused by deformation of the support 18.

From this point, the thermal expansion coefficient of the support 18 is less than 1×10⁻⁵/° C. In addition, since it is desirable that the support 18 has a high transmittance and a high refractive index, it is preferable to use optical glass. In general, the thermal expansion coefficient of optical glass is 1×10⁻⁶/° C. to 1×10⁻⁵/° C.

The thermal expansion coefficient of the support 18 can be measured by, for example, a known method such as JIS K 7197.

In addition, for example, the thermal expansion coefficient of the support 18 is determined by measuring thermomechanical properties using a thermomechanical analyzer (TMA4000SE manufactured by NETZSCH). As the measurement conditions, for example, the sample size is set to 5 mm×20 mm, the distance between chucks is set to 15 mm, the lengths of both the upper chuck and the lower chuck are set to 2.5±0.5 mm, and the temperature is changed in a range of −20° C. to 60° C. at 5° C./min, and the amount of displacement of the chuck distance is measured. Further, the measurement is performed by applying a constant load of 3 g to the sample as the load. Next, a slope of an approximate straight line of data regarding the displacement in the range of −20° C. to 60° C. is obtained to obtain the displacement per temperature of 1° C. Further, by dividing the slope by 15 mm that is the chuck-to-chuck distance when the sample is set, the thermal expansion coefficient can be calculated.

In a case where the support 18 is a laminate having a plurality of layers such as a configuration in which the support 18 includes a substrate and an alignment film and a configuration in which the support 18 includes a substrate and an adhesive layer, the thermal expansion coefficient of the laminate may be in the above-described range. For example, the alignment film is extremely thin, and the thermal expansion coefficient of the substrate can be substantially regarded as the thermal expansion coefficient of the support 18.

### <Optical Functional Layer>

The optical functional layer 12 is a layer formed of a liquid crystal composition containing a liquid crystal compound, and is a layer having a liquid crystal alignment pattern in which an orientation of an optical axis derived from the liquid crystal compound changes while continuously rotating along at least one in-plane direction.

FIG. 5 is a diagram conceptually showing an example of the liquid crystal alignment pattern of the optical functional layer 12. FIG. 6 is a partial cross-sectional view of the optical functional layer 12 shown in FIG. 5.

The optical functional layer 12 shown in FIGS. 5 and 6 acts as a liquid crystal lens, and is a liquid crystal layer formed of a liquid crystal composition containing a liquid crystal compound 40.

The optical functional layer 12 has a liquid crystal alignment pattern in which an orientation of an optical axis derived from the liquid crystal compound 40 changes while continuously rotating along at least one in-plane direction. In addition, in a preferable aspect, in the liquid crystal alignment pattern, in a case where a length over which the orientation of the optical axis derived from the liquid crystal compound 40 rotates by 180° in a plane is set as a single period, the optical functional layer 12 has regions having different lengths of the single period in the plane.

Specifically, the optical functional layer 12 shown in FIG. 5 has the liquid crystal alignment pattern in which the orientation of the optical axis derived from the liquid crystal compound 40 changes while continuously rotating in one direction, in a radial shape from an inner side toward an outer side. That is, the liquid crystal alignment pattern of the optical functional layer 12 shown in FIGS. 5 and 6 is a pattern having a plurality of rings, in which rings having the same orientation of the optical axis derived from the liquid crystal compound 40 are arranged in a circular shape, and rings having different orientations of the optical axis are concentrically arranged.

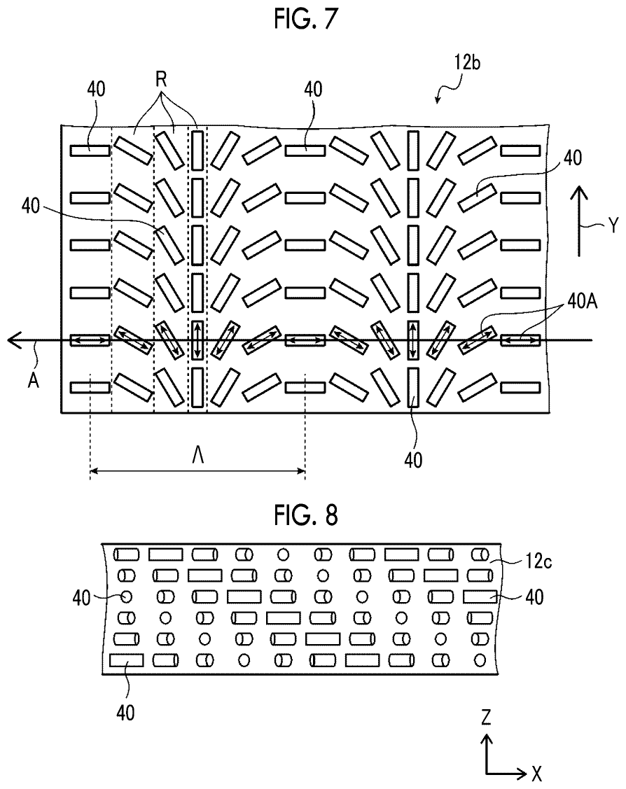

In FIGS. 5 and 7 described below, in order to simplify the drawing and to clarify the configuration of the optical functional layer 12, only the liquid crystal compound 40 at an interface on the alignment film side of the optical functional layer 12 is shown. However, as shown in FIG. 6, the optical functional layer 12 has a configuration in which the liquid crystal compounds 40 are laminated in the thickness direction, similarly to the liquid crystal layer formed of a composition including a typical liquid crystal compound. In FIGS. 5 and 6, for example, a rod-like liquid crystal compound is used as the liquid crystal compound 40. Therefore, the direction of the optical axis matches a longitudinal direction of the liquid crystal compound 40.

Specifically, in the optical functional layer 12 shown in FIG. 5, the orientation of the optical axis of the liquid crystal compound 40 changes while continuously rotating in a plurality of directions from the center of the optical functional layer 12 toward the outer side, for example, a direction indicated by an arrow A₁, a direction indicated by an arrow A₂, a direction indicated by an arrow A₃, a direction indicated by an arrow A₄, or . . . . Accordingly, in the optical functional layer 12, the rotation direction of the optical axis of the liquid crystal compound 40 is the same in all directions (one direction) from the center toward the outer side. In the example shown in the drawing, the rotation direction of the optical axis of the liquid crystal compound 40 is counterclockwise, in all the directions including the direction indicated by the arrow A₁, the direction indicated by the arrow A₂, the direction indicated by the arrow A₃, and the direction indicated by the arrow A₄.

That is, in a case where the arrow A₁ and the arrow A₄ are regarded as one straight line, the rotation direction of the optical axis of the liquid crystal compound 40 is reversed at the center of the optical functional layer 12 on the straight line. As an example, it is assumed that the straight line formed by the arrow A₁ and the arrow A₄ is directed toward the right direction (arrow A₁ direction) in the figure. In this case, the optical axis of the liquid crystal compound 40 initially rotates clockwise from the outer direction of the optical functional layer 12 toward the center, the rotation direction is reversed at the center of the optical functional layer 12, and then the optical axis rotates counterclockwise from the center of the optical functional layer 12 toward the outer direction. The center of the optical functional layer 12 is an optical axis of the liquid crystal lens.

As is well known, the liquid crystal layer (optically anisotropic layer) having a liquid crystal alignment pattern in which the orientation of the optical axis derived from the liquid crystal compound 40 changes while continuously rotating in one direction acts as a transmissive liquid crystal diffraction element that diffracts entering circularly polarized light in one direction along which the optical axis rotates and the reverse direction, depending on the rotation direction of the optical axis and the turning direction of the entering circularly polarized light.

In the optical functional layer 12 having the liquid crystal alignment pattern in which the orientation of the optical axis of the liquid crystal compound 40 changes while continuously rotating in one direction, a diffraction direction (refraction direction) of transmitted light depends on the rotation direction of the optical axis of the liquid crystal compound 40. That is, in the liquid crystal alignment pattern, in a case where the rotation directions of the optical axes of the liquid crystal compounds 40 in the one direction are opposite to each other, the diffraction direction of transmitted light is opposite to the one direction in which the optical axis rotates.

In addition, in the optical functional layer 12 having the liquid crystal alignment pattern in which the orientation of the optical axis of the liquid crystal compound 40 changes while continuously rotating in one direction, the diffraction direction of the transmitted light varies depending on the revolution direction of the incident circularly polarized light. That is, in the liquid crystal alignment pattern, the diffraction direction of transmitted light is reversed between a case where the entering light is dextrorotatory circularly polarized light and a case where the entering light is levorotatory circularly polarized light.

Further, in a case where the value of the in-plane retardation (retardation in the plane direction) is set to λ/2, the optical functional layer 12 has a function as a general ½ wave plate, that is, a function of imparting a phase difference of a half wavelength, that is, 180° to a polarized light component incident into the liquid crystal layer. Accordingly, the revolution direction of the circularly polarized light incident into and diffracted by the optical functional layer 12 is reversed. That is, the dextrorotatory circularly polarized light incident into and diffracted by the optical functional layer 12 is emitted as levorotatory circularly polarized light, and the levorotatory circularly polarized light is emitted as dextrorotatory circularly polarized light.

In the optical functional layer 12 that acts as a liquid crystal lens, in the liquid crystal alignment pattern, in a case where a length over which the orientation of the optical axis derived from the liquid crystal compound rotates by 180° in the one direction in which the orientation of the optical axis of the liquid crystal compound 40 changes while continuously rotating is set as a single period, the length of the single period gradually decreases from the inner side toward the outer side. That is, the optical functional layer 12 in the example shown in the drawing has regions where the lengths of the single periods are different from each other in the plane.

Here, in the liquid crystal layer having a liquid crystal alignment pattern in which the orientation of the optical axis of the liquid crystal compound 40 changes while continuously rotating in one direction, the shorter the length of the single period, the larger the diffraction angle. Accordingly, in the optical functional layer 12 having the concentric liquid crystal alignment pattern, the diffraction angle gradually increases from the center of the concentric circle toward the outer direction.

Accordingly, the optical functional layer 12 having the concentric liquid crystal alignment pattern in which the liquid crystal alignment pattern in which the optical axis derived from the liquid crystal compound changes while continuously rotating is radially provided can transmit the incident ray by causing the incident ray to diverge or converge depending on the rotation direction of the optical axis of the liquid crystal compound 40 and the revolution direction of the incident circularly polarized light. In other words, the liquid crystal lens having the optical functional layer 12 acts as, for example, a concave lens in a case where dextrorotatory circularly polarized light is incident and acts as a convex lens in a case where levorotatory circularly polarized light is incident, depending on the revolution direction of the incident circularly polarized light. Alternatively, A the optical functional layer 12 acts as a convex lens in a case where dextrorotatory circularly polarized light is incident and acts as a concave lens in a case where levorotatory circularly polarized light is incident. In the example shown in the drawing, for example, the optical functional layer 12 acts as a convex lens to condense light in a case where levorotatory circularly polarized light is incident and acts as a concave lens to cause light to diverge in a case where dextrorotatory circularly polarized light is incident.

In the examples shown in FIGS. 5 and 6, the optical functional layer 12 has the liquid crystal alignment pattern in which the one direction in which the orientation of the optical axis of the liquid crystal compound 40 changes while continuously rotating is radially provided, but the present invention is not limited to this.

FIG. 7 is a diagram conceptually showing another example of the liquid crystal alignment pattern of the optical functional layer 12.

Even in the concentric liquid crystal alignment pattern in which the one direction in which the optical axis changes while continuously rotating is radially provided from the inner side toward the outer side, the same optical action effect as that of the liquid crystal alignment pattern shown in FIG. 7 is exhibited with respect to the one direction in which the optical axis changes while continuously rotating.

In the following description, an optical axis 40A derived from the liquid crystal compound 40 will also be referred to as “the optical axis 40A of the liquid crystal compound 40” or “the optical axis 40A”.

In an optical functional layer 12b shown in FIG. 7, the liquid crystal compound 40 is two-dimensionally aligned in a plane parallel to the one direction indicated by an arrow A and a Y direction orthogonal to the arrow A direction. In FIGS. 6 and 8 described below, the Y direction is a direction orthogonal to the paper plane. In the following description, “one direction indicated by the arrow A” will also be simply referred to as “arrow A direction”.

In the optical functional layer 12 shown in FIG. 5, the circumferential direction of the concentric circle in the concentric liquid crystal alignment pattern corresponds to the Y direction in FIG. 7.

The optical functional layer 12b has a liquid crystal alignment pattern in which the orientation of the optical axis 40A derived from the liquid crystal compound 40 changes while continuously rotating in the arrow A direction in a plane of the optical functional layer 12b.

Specifically, the fact that the orientation of the optical axis 40A of the liquid crystal compound 40 changes while continuously rotating in the arrow A direction (the predetermined one direction) means that an angle between the optical axis 40A of the liquid crystal compound 40 arranged in the arrow A direction and the arrow A direction varies depending on positions in the arrow A direction, and the angle between the optical axis 40A and the arrow A direction sequentially changes from θ to θ+180° or θ-180° in the arrow A direction.

Meanwhile, regarding the liquid crystal compound 40 forming the optical functional layer 12b, the liquid crystal compounds 40 in which the orientations of the optical axes 40A are the same as one another are arranged at equal intervals in the Y direction orthogonal to the arrow A direction, that is, the Y direction orthogonal to one direction in which the optical axes 40A continuously rotate.

In other words, in the liquid crystal compound 40 forming the optical functional layer 12b, the angles between the orientations of the optical axes 40A and the arrow A direction are the same in the liquid crystal compounds 40 arranged in the Y direction.

In the optical functional layer 12 shown in FIG. 5, regions where the orientations of the optical axes 40A are the same are formed in an annular shape having the same center, and a concentric liquid crystal alignment pattern is formed.

As described above, in the liquid crystal alignment pattern in which the optical axis 40A continuously rotates in the one direction, the length (distance) over which the optical axis 40A of the liquid crystal compound 40 rotates by 180° is the length Λ of the single period in the liquid crystal alignment pattern.

That is, in the optical functional layer 12b shown in FIG. 7, the length (distance) over which the optical axis 40A of the liquid crystal compound 40 rotates by 180° in the arrow A direction in which the orientation of the optical axis 40A changes while continuously rotating in a plane is set as the single period A in the liquid crystal alignment pattern. In other words, the single period A in the liquid crystal alignment pattern is defined as a distance from θ to θ+180° of the angle between the optical axis 40A of the liquid crystal compound 40 and the arrow A direction.

In other words, the distance between the centers of two liquid crystal compounds 40 in the arrow A direction, where the angles with respect to the arrow A direction are the same, is the length Λ of the single period. Specifically, as shown in FIG. 7, a distance between centers in the arrow A direction of two liquid crystal compounds 40 in which the arrow A direction and the direction of the optical axis 40A match with each other is the single period A.

In the optical functional layer 12b, the liquid crystal alignment pattern is formed by repeating the single period A in the arrow A direction, that is, in the one direction in which the orientation of the optical axis 40A continuously rotates and changes.

As described above, the optical functional layer 12b having such a liquid crystal alignment pattern is also a transmissive liquid crystal diffraction element, and the single period A is the period (single period) of the diffraction structure.

In the optical functional layer 12b, the liquid crystal compounds arranged in the Y direction have the same angle between the optical axis 40A and the arrow A direction. A region where the liquid crystal compounds 40 in which the angles between the optical axes 40A and the arrow A direction are the same are arranged in the Y direction will be referred to as a region R.

In this case, it is preferable that the value of the in-plane retardation (Re) in each region R is a half wavelength, that is, λ/2. The in-plane retardation is calculated from the product of the difference Δn in refractive index due to the refractive index anisotropy of the region R and the thickness of the optical functional layer 12b. The refractive index difference caused by the refractive index anisotropy of the regions R is a refractive index difference defined as a difference between refractive indices in directions of the slow axes in planes of the regions R and refractive indices in directions orthogonal to the directions of the slow axes. That is, the difference in refractive index Δn due to the refractive index anisotropy of the regions R is the same as a difference between a refractive index of the liquid crystal compound 40 in the direction of the optical axis 40A and a refractive index of the liquid crystal compound 40 in the direction perpendicular to the optical axis 40A in the plane of the region R. That is, the refractive index difference Δn is equal to a refractive index difference between the liquid crystal compounds.

In the liquid crystal lens having a concentric liquid crystal alignment pattern, in which the liquid crystal alignment pattern in which the optical axis 40A continuously rotates in one direction is radial, regions where the optical axis 40A is oriented in the same direction, which are formed in annular shapes with their centers matching each other correspond to the regions R in FIG. 7.

In a case where circularly polarized light is incident into the optical functional layer 12b, the light is diffracted and the direction of the circularly polarized light is converted. Hereinafter, this action will be described. In the optical functional layer 12b, it is assumed that the value of the product of the difference in refractive index of the liquid crystal compound and the thickness of the liquid crystal layer is λ/2.

As described above, this action is also completely the same as that in the liquid crystal lens 34 having a concentric liquid crystal alignment pattern, in which the liquid crystal alignment pattern in which the optical axis 40A continuously rotates in one direction is radial.

In a case where the value of the product of the difference in refractive index of the liquid crystal compound and the thickness of the liquid crystal layer in the optical functional layer 12b is λ/2, in a case where incident ray that is levorotatory circularly polarized light is incident into the optical functional layer 12b, the incident ray transmits through the optical functional layer 12b to be imparted with a retardation of 180°, and the transmitted light is converted into dextrorotatory circularly polarized light. In addition, since the liquid crystal alignment pattern formed in the optical functional layer 12b is a pattern that is periodic in the arrow A direction, the transmitted light travels in a direction different from the traveling direction of the incident ray. As described above, the incident ray of levorotatory circularly polarized light is converted into the transmitted light of dextrorotatory circularly polarized light that is tilted by a certain angle in the arrow A direction with respect to the incidence direction.

On the other hand, in a case where the value of the product of the difference in refractive index of the liquid crystal compound and the thickness of the liquid crystal layer in the optical functional layer 12b is λ/2, in a case where incident ray of dextrorotatory circularly polarized light is incident into the optical functional layer 12b, the incident ray transmits through the optical functional layer 12b to be imparted with a retardation of 180°, and the transmitted light is converted into levorotatory circularly polarized light. In addition, since the liquid crystal alignment pattern formed in the optical functional layer 12b is a pattern that is periodic in the arrow A direction, the transmitted light travels in a direction different from the traveling direction of the incident ray. In this case, the transmitted light travels in a direction different from the transmitted light, that is, in a direction opposite to the arrow A direction with respect to the incidence direction. As described above, the incident ray is converted into the transmitted light of levorotatory circularly polarized light that is tilted by a certain angle in the arrow A direction with respect to the incidence direction.

In the optical functional layer 12b, it is preferable that the value of the in-plane retardation of the plurality of regions R is a half wavelength, but it is preferable that the in-plane retardation Re(550)=Δn550×d of the plurality of regions R of the optical functional layer 12b with respect to the incident ray having a wavelength of 550 nm is within a range defined by Expression (1). Here, Δn550 represents a difference in refractive index associated with the refractive index anisotropy of the region R in a case where the wavelength of the incident ray is 550 nm, and d represents the thickness of the optical functional layer 12b.

$$200 nm \leq Δ n 550 \times d \leq 350 nm \qquad ( 1 )$$

That is, in a case where the in-plane retardation Re(550)=Δn550×d of the plurality of regions R of the optical functional layer 12b satisfies Expression (1), a sufficient amount of circularly polarized light components of light incident into the optical functional layer 12b can be converted into circularly polarized light that travels in a direction tilted in the forward direction or the backward direction with respect to the arrow A direction. It is more preferable that the in-plane retardation Re(550)=Δn550×d satisfies 225 nm≤Δn550 xd≤340 nm, and it is still more preferable that the in-plane retardation Re(550)=Δn550×d satisfies 250 nm≤Δn550×d≤330 nm.

Expression (1) is a range with respect to incident ray having a wavelength of 550 nm. However, an in-plane retardation Re(λ)=Δnλ×d of the plurality of regions R of the liquid crystal layer with respect to incident ray having a wavelength of 2 nm is preferably in a range defined by the following Expression (1-2) and can be appropriately set.

$$0.7 \times ( λ / 2 ) nm \leq Δ n λ \times d \leq 1.3 \times ( λ / 2 ) nm \qquad ( 1 - 2 )$$

In addition, the value of the in-plane retardation of the plurality of regions R in the optical functional layer 12b can also be used outside the range of Expression (1). Specifically, by adopting Δn550×d<200 nm or 350 nm≤Δn550× d, light can be classified into light which travels in the same direction as a traveling direction of the incident ray and light which travels in a direction different from a traveling direction of the incident ray. In a case where Δn550×d approaches 0 nm or 550 nm, the light component traveling in the same direction as the traveling direction of the incident ray increases, and the light component traveling in a direction different from the traveling direction of the incident ray decreases.

As described above, in the optical functional layer 12b, the angle of diffraction of transmitted light can be adjusted by changing the single period A of the formed liquid crystal alignment pattern. Specifically, as the single period A of the liquid crystal alignment pattern decreases, light transmitted through the liquid crystal compounds 40 adjacent to each other more strongly interfere with each other, so that the transmitted light can be more largely diffracted.

In addition, in the optical functional layer 12b, the direction (azimuthal direction) of diffraction of transmitted light can be reversed by reversing the rotation direction of the optical axis 40A of the liquid crystal compound 40 rotating along the arrow A direction.

Further, as described above, in the optical functional layer 12b, the direction (azimuthal direction) of diffraction of transmitted light is reversed depending on the revolution direction of incident circularly polarized light. That is, in the optical functional layer 12b, the direction (azimuthal direction) of diffraction of transmitted light is reversed between dextrorotatory circularly polarized light and levorotatory circularly polarized light.

Regarding the above-described point, the same applies to the optical functional layer 12 having a concentric liquid crystal alignment pattern.

Here, in the example shown in FIG. 6, the optical axes of the liquid crystal compounds arranged in the thickness direction are aligned in the same direction, but the present invention is not limited to this. The optical functional layer may have, in a plane, a region where the optical axis of the liquid crystal compound is twisted along the thickness direction. At this time, in the region having the twisted structure in the thickness direction, a twisted angle over the entire area in the thickness direction is 10° to 360°.

In the optical functional layer 12 (12b), by adopting a configuration in which the region where the optical axis of the liquid crystal compound is twisted in the thickness direction is provided, the diffraction efficiency of light can be increased.

In addition, in the above-described example, the optical functional layer 12 (12b) is a transmissive liquid crystal lens or a transmissive liquid crystal diffraction element that transmits light, but the present invention is not limited to this. The optical functional layer may be a cholesteric liquid crystal layer having a helical structure where the optical axis of the liquid crystal compound is twisted in the thickness direction.

FIG. 8 conceptually shows another example of the optical functional layer. An optical functional layer 12c shown in FIG. 8 is a cholesteric liquid crystal layer where the optical axis of the liquid crystal compound is twisted in the thickness direction. In addition, the optical functional layer 12c has a liquid crystal alignment pattern where the orientation of the optical axis derived from the liquid crystal compound changes while continuously rotating along at least one in-plane direction. The liquid crystal alignment pattern of the optical functional layer 12c may be the concentric liquid crystal alignment pattern shown in FIG. 5 described above or the liquid crystal alignment pattern shown in FIG. 7 where the orientation of the optical axis derived from the liquid crystal compound changes while continuously rotating in one direction.

The optical functional layer 12c that is a cholesteric liquid crystal layer has a helical structure where the liquid crystal compound 40 is helically turned and laminated, and has a structure where a plurality of pitches of the helically turned liquid crystal compound 40 are laminated, with a configuration where the liquid crystal compound 40 is helically rotated once (rotated by) 360° and laminated as one helical pitch, similarly to a cholesteric liquid crystal layer obtained by fixing a typical cholesteric liquid crystalline phase.

As is well known, the cholesteric liquid crystal layer has wavelength-selective reflectivity. For example, in a case where the cholesteric liquid crystal layer is a cholesteric liquid crystal layer having a selective reflection center wavelength in a green wavelength range, the cholesteric liquid crystal layer reflects dextrorotatory circularly polarized light of green light and transmits the other light.

Here, in a case where the optical functional layer 12c has the liquid crystal alignment pattern where the liquid crystal compound 40 is aligned by rotating in one direction in the plane direction as in the example shown in FIG. 7, the incident circularly polarized light is refracted (diffracted) in a direction in which the orientation of the optical axis continuously rotates and is reflected. At this time, the diffraction azimuthal direction varies depending on a turning direction of the incident circularly polarized light. That is, the optical functional layer 12c reflects dextrorotatory circularly polarized light or levorotatory circularly polarized light having a selective reflection wavelength and diffracts the reflected light.

In addition, in a case where the optical functional layer 12c has the concentric liquid crystal alignment pattern having the one direction in which the liquid crystal compound 40 is aligned by rotating in a radial shape as in the example shown in FIG. 5, the incident circularly polarized light is condensed or diffracted and reflected. In this case, the light is condensed or diffracted depending on the turning direction of the incident circularly polarized light. That is, the optical functional layer 12c reflects dextrorotatory circularly polarized light or levorotatory circularly polarized light having a selective reflection wavelength and condenses or diffracts the reflected light.

The optical functional layers 12, 12b, and 12c can be formed by fixing a liquid crystal phase aligned in a liquid crystal alignment pattern where the orientation of the optical axis derived from the liquid crystal compound changes while continuously rotating along at least one in-plane direction in a layer shape.

The structure in which a liquid crystal phase is immobilized may be a structure in which the alignment of the liquid crystal compound as a liquid crystal phase is maintained. Typically, the structure in which a liquid crystal phase is immobilized is preferably a structure which is obtained by aligning the polymerizable liquid crystal compound in the liquid crystal alignment pattern, polymerizing and curing the polymerizable liquid crystal compound with ultraviolet irradiation, heating, or the like to form a layer having no fluidity, and concurrently changing the state of the polymerizable liquid crystal compound into a state where the orientation state is not changed by an external field or an external force.

In the structure in which the liquid crystal phase is fixed, it is sufficient that the optical properties of the liquid crystal phase are maintained, and the liquid crystal compound in the optical functional layer may not exhibit liquid crystallinity. For example, the molecular weight of the polymerizable liquid crystal compound may be increased by the curing reaction and the liquid crystallinity may be lost.

Examples of a material used for forming the optical functional layer in which the liquid crystal phase is fixed include a liquid crystal composition containing a liquid crystal compound. The liquid crystal compound is preferably a polymerizable liquid crystal compound. In addition, the liquid crystal composition used for forming the optical functional layer may further contain a surfactant, a polymerization initiator, and the like. In addition, in a case where the optical functional layer is a cholesteric liquid crystal layer in which the liquid crystal compound is twisted and aligned in the thickness direction, the liquid crystal composition may contain a chiral agent.

### —Polymerizable Liquid Crystal Compound—

The polymerizable liquid crystal compound may be a rod-like liquid crystal compound or a disk-like liquid crystal compound.

Examples of the rod-like polymerizable liquid crystal compound forming the optical functional layer include a rod-like nematic liquid crystal compound. As the rod-like nematic liquid crystal compound, an azomethine compound, an azoxy compound, a cyanobiphenyl compound, a cyanophenyl ester compound, a benzoate compound, a phenyl cyclohexanecarboxylate compound, a cyanophenylcyclohexane compound, a cyano-substituted phenylpyrimidine compound, an alkoxy-substituted phenylpyrimidine compound, a phenyldioxane compound, a tolane compound, or an alkenylcyclohexylbenzonitrile compound is preferably used. High-molecular liquid crystal compounds can also be used as well as low-molecular liquid crystal compounds.

The polymerizable liquid crystal compound is obtained by introducing a polymerizable group into the liquid crystal compound. Examples of the polymerizable group include an unsaturated polymerizable group, an epoxy group, and an aziridinyl group. Among these, an unsaturated polymerizable group is preferable, and an ethylenically unsaturated polymerizable group is more preferable. The polymerizable group can be introduced into the molecules of the liquid crystal compound using various methods. The number of polymerizable groups included in the polymerizable liquid crystal compound is preferably 1 to 6 and more preferably 1 to 3.

Examples of the polymerizable liquid crystal compound include compounds described in “Makromol. Chem., vol. 190, p. 2255 (1989), Advanced Materials, vol. 5, p. 107 (1993)”, U.S. Pat. Nos. 4,683,327A, 5,622,648A, 5,770,107A, WO1995/22586A, WO1995/24455A, WO1997/00600A, WO1998/23580A, WO1998/52905A, JP1989-272551A (JP-H1-272551A), JP1994-016616A (JP-H6-016616A), JP1995-110469A (JP-H7-110469A), JP1999-080081A (JP-H11-080081A), JP2001-328973A, and the like. Two or more polymerizable liquid crystal compounds may be used in combination. In a case where two or more kinds of polymerizable liquid crystal compounds are used in combination, an alignment temperature can be decreased.

In addition, as a polymerizable liquid crystal compound other than the above-described examples, for example, such a cyclic organopolysiloxane compound having a cholesteric phase as described in JP1982-165480A (JP-S57-165480A) can be used. Further, as the above-described polymer liquid crystal compound, for example, a polymer in which a liquid crystal mesogenic group is introduced into the main chain, a side chain, or both the main chain and a side chain, a polymer cholesteric liquid crystal in which a cholesteryl group is introduced into a side chain, such a liquid crystal polymer as described in JP1997-133810A (JP-H9-133810A), and such a liquid crystal polymer as described in JP1999-293252A (JP-H11-293252A) can be used.

### —Disk-Like Liquid Crystal Compound—

Compounds described in JP2007-108732A and JP2010-244038A can be, for example, preferably used as disk-like liquid crystal compounds.

In addition, the addition amount of the polymerizable liquid crystal compound in the liquid crystal composition is preferably 75% to 99.9 mass %, more preferably 80% to 99 mass %, and still more preferably 85% to 90 mass % with respect to the solid content mass (mass excluding a solvent) of the liquid crystal composition.

### —Chiral Agent (Optically Active Compound)—

The chiral agent has a function of inducing a helical structure of a liquid crystal phase. The chiral agent may be selected depending on the purposes since a helical twisted direction and a helical twisting power (HTP) to be induced vary depending on compounds.

The chiral agent is not particularly limited, and a well-known compound (for example, Liquid Crystal Device Handbook (No. 142 Committee of Japan Society for the Promotion of Science, 1989), Chapter 3, Article 4-3, chiral agent for twisted nematic (TN) or super twisted nematic (STN), p. 199), isosorbide, or an isomannide derivative can be used.

In general, the chiral agent includes a chiral carbon atom. However, an axially chiral compound or a planar chiral compound not having a chiral carbon atom can also be used as the chiral agent. Examples of the axially chiral compound or the planar chiral compound include binaphthyl, helicene, paracyclophane, and derivatives thereof. The chiral agent may also have a polymerizable group. In a case where both the chiral agent and the liquid crystal compound have a polymerizable group, a polymer having a repeating unit induced from the polymerizable liquid crystal compound and a repeating unit induced from the chiral agent can be formed by a polymerization reaction between the polymerizable chiral agent and the polymerizable liquid crystal compound. In this aspect, it is preferable that the polymerizable group in the polymerizable chiral agent is the same as the polymerizable group in the polymerizable liquid crystal compound. Accordingly, the polymerizable group of the chiral agent is preferably an unsaturated polymerizable group, an epoxy group, or an aziridinyl group, more preferably an unsaturated polymerizable group, and still more preferably an ethylenically unsaturated polymerizable group. Further, the chiral agent may be a liquid crystal compound.

In a case where the chiral agent includes a photoisomerization group, a desired twisted alignment corresponding to a luminescence wavelength can be formed by irradiation of an actinic ray or the like through a photomask after coating and alignment, which is preferable. As the photoisomerizable group, an isomerizable site of a compound exhibiting photochromic properties, an azo group, an azoxy group, or a cinnamoyl group is preferable. Specific examples of the compound include compounds described in JP2002-80478A, JP2002-80851A, JP2002-179668A, JP2002-179669A, JP2002-179670A, JP2002-179681A, JP2002-179682A, JP2002-338575A, JP2002-338668A, JP2003-313189A, and JP2003-313292A.

The content of the chiral agent in the liquid crystal composition is preferably 0.01% to 200% by mole, and more preferably 1% to 30% by mole with respect to the molar content of the liquid crystal compound.

### [Edge Surface Covering Layer]

The edge surface covering layer 20 covers a position of an interface between the support 18 and the optical functional layer 12 (12b and 12c) on the edge surface of the first laminate 14.

A material for forming the edge surface covering layer 20 may be an organic material (organic material) or an inorganic material (inorganic material). Examples of the organic material include resins such as an acrylic resin, an epoxy resin, a silicone resin, and urethane. Among these, from the viewpoint of suppressing peeling of the corner portion of the optical functional layer 12 from the support 18, the material for forming the edge surface covering layer 20 preferably contains any one of an acrylic resin, an epoxy resin, or a silicone resin.

In addition, examples of the inorganic material as the material for forming the edge surface covering layer 20 include metals such as aluminum, chromium, and nickel, silicon nitride, silicon oxide, and aluminum oxide.

In a case where the material for forming the edge surface covering layer 20 is an organic material, it is preferable that the edge surface covering layer 20 contains a light absorbing material. By containing the light absorbing material, it is possible to suppress the light incident on the optical laminate from being reflected by the edge surface covering layer 20 to be converted to unnecessary noise light.

The light absorbing material is not particularly limited, and a well-known light absorbing material can be used depending on a wavelength range to be absorbed. For example, in a case where the light to be absorbed is visible light, a known light absorbing agent such as an inorganic pigment, an organic pigment such as an insoluble azo pigment, and a dye such as azo or anthraquinone can be used. The inorganic pigment is a composite oxide-based pigment, and for example, cobalt green (TiO₂·CoO·NiO·ZrO₂ or CoO·Cr₂O₃·TiO₂·Al₂O₃) is exemplified as green, cobalt blue (CoO· Al₂O₃) is exemplified as blue, and iron oxide (Fe₂O₃) is exemplified as red. As a material having absorption in blue-green, lead molybdate and lead chromate, and a formulation thereof are exemplified. In addition, the light absorbing material may be configured to have two or more kinds of light absorbing materials that absorb light in different wavelength ranges.

A method of forming the edge surface covering layer 20 in a case where the edge surface covering layer 20 is an organic material is not particularly limited. Examples thereof include a method of applying a coating liquid for forming the edge surface covering layer 20 onto the edge surface of the first laminate using a dispenser. In this case, by using a dispenser having a precision position adjustment mechanism, the coating can be accurately applied onto the edge surface of the first laminate. In addition, the coating range of the edge surface, the width of the landing on the main surface, and the like can also be adjusted by adjusting the discharge position of the dispenser using the precision position adjustment mechanism. In addition, the thickness of the edge surface covering layer 20 can be adjusted by the discharge amount of the dispenser.

The coating film applied onto the edge surface of the first laminate 14 may be subjected to a drying treatment, a curing treatment, or the like as necessary. The curing method may be performed by a known method such as thermal curing or ultraviolet curing depending on the forming material.

A method of forming the edge surface covering layer 20 in a case where the edge surface covering layer 20 is an inorganic material is not particularly limited, and the edge surface covering layer 20 may be formed by a known forming method depending on the type of the inorganic material. For example, a region where the edge surface covering layer 20 is not formed may be masked, and the edge surface covering layer 20 may be formed by a known film forming method such as vapor deposition, sputtering, or plasma chemical vapor deposition (CVD).

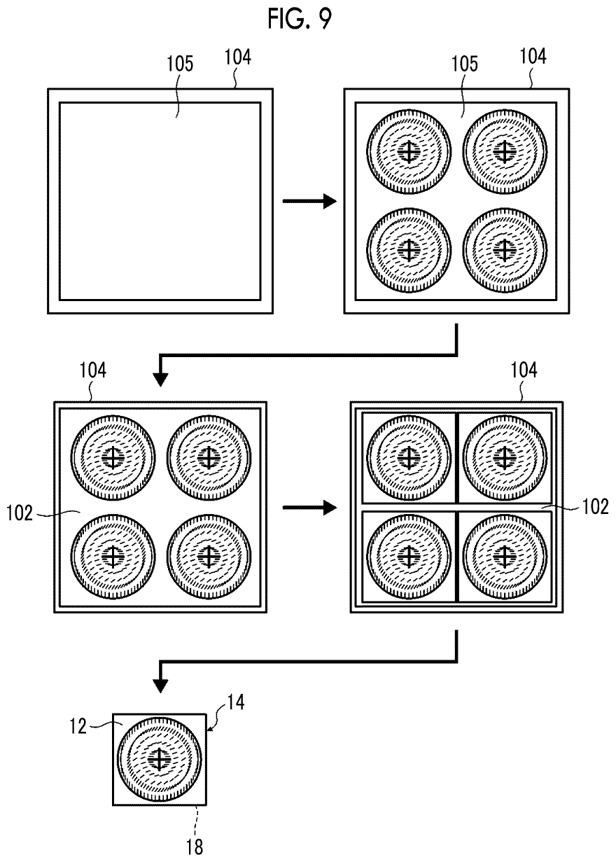

Next, an example of a manufacturing method of the optical laminate will be described with reference to FIG. 9. In the example shown in FIG. 9, the optical laminate is obtained by laminating an optical functional layer having a region exhibiting a function as a liquid crystal lens (liquid crystal diffractive lens) on a support.

First, as shown on the left side of the upper part of FIG. 9, a coating liquid for forming an alignment film 105 is applied onto a substrate 104 to form a coating film. Next, the coating film is exposed to form an alignment pattern corresponding to the liquid crystal alignment pattern of the optical functional layer (right side of the upper part of FIG. 9). In the example shown in the drawing, four regions of one coating film are exposed to form four alignment patterns.

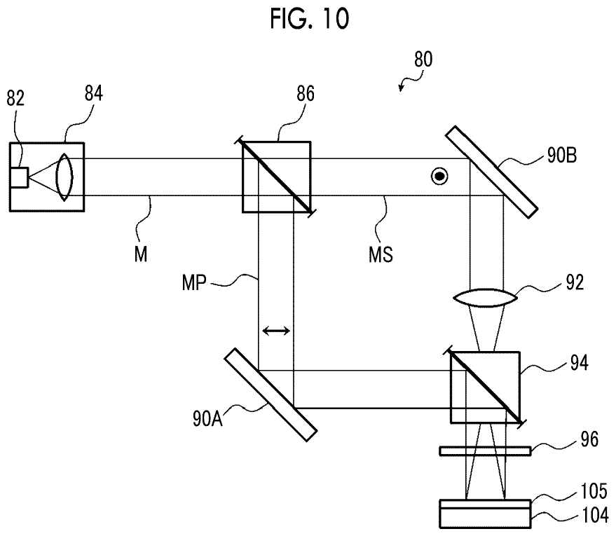

FIG. 10 conceptually shows an example of an exposure device that exposes a coating film serving as the alignment film 105 (photo-alignment film) for forming the optical functional layer 12 to form an alignment pattern corresponding to a concentric liquid crystal alignment pattern in which an optical axis changes while continuously rotating in a radial shape.

An exposure device 80 shown in FIG. 10 includes a light source 84 which comprises a laser 82, a polarization beam splitter 86 which splits a laser light M emitted from the laser 82 into an S-polarized light MS and a P-polarized light MP, a mirror 90A which is disposed on an optical path of the P-polarized light MP and a mirror 90B which is disposed on an optical path of the S-polarized light MS, a lens 92 which is disposed on the optical path of the S-polarized light MS, a beam splitter 94, and a ¼ plate 96.

The P-polarized light MP which is split by the polarization beam splitter 86 is reflected from the mirror 90A to be incident into the beam splitter 94. On the other hand, the S-polarized light MS that is split by the polarization beam splitter 86 is reflected from the mirror 90B and is collected by the lens 92 to be incident into the beam splitter 94.

The P-polarized light MP and the S-polarized light MS are multiplexed by the beam splitter 94, are converted into dextrorotatory circularly polarized light and levorotatory circularly polarized light corresponding to the polarization direction by the ¼ plate 96, and are incident into the coating film (alignment film 105) on the substrate 104.

Here, due to interference between the dextrorotatory circularly polarized light and the levorotatory circularly polarized light, the polarization state of light with which the alignment film 105 is irradiated periodically changes according to interference fringes. Since the intersecting angle between the levorotatory circularly polarized light and the dextrorotatory circularly polarized light changes from the inner side toward the outer side of the concentric circle, an exposure pattern in which the pitch (single period) gradually decreases from the inner side toward the outer side can be obtained. As a result, in the alignment film 105, a concentric (radial) alignment pattern in which the orientation state periodically changes can be obtained.

In the exposure device 80, a single period A in the liquid crystal alignment pattern in which the optical axis of the liquid crystal compound 40 continuously rotates by 180° along one direction can be controlled by changing the optical power of the lens 92, the focal length of the lens 92, the distance between the lens 92 and the alignment film 105, and the like.

In addition, by adjusting the optical power of the lens 92 (the F number of the lens 92), the length of the single period in the liquid crystal alignment pattern in the one in-plane direction in which the optical axis continuously rotates can be changed.

Specifically, the length of the single period in the liquid crystal alignment pattern in the in-plane direction in which the optical axis continuously rotates can be changed depending on a light spread angle at which light is spread by the lens 92 due to interference with parallel light. More specifically, in a case where the focal power of the lens 92 is decreased, the light is close to the parallel light, so that the length Λ of the single period in the liquid crystal alignment pattern is gradually decreased from the inner side toward the outer side. Conversely, in a case where the optical power of the lens 92 is increased, the length Λ of the single period in the liquid crystal alignment pattern rapidly decreases from the inner side toward the outer side.

That is, by adjusting the refractive index of the lens 92, the refractive index of the liquid crystal lens (optical functional layer 12) that acts as a concave lens or a convex lens depending on the revolution direction of the incident circularly polarized light can be adjusted.

Next, the liquid crystal composition containing the liquid crystal compound for forming the above-described optical functional layer 12 is applied onto the formed exposed alignment film 105, dried, and further cured by ultraviolet irradiation or the like as necessary. As a result, as shown on the left side in the middle of FIG. 9, a liquid crystal layer 102 having a plurality of regions having a concentric liquid crystal alignment pattern is formed.

In the example shown in FIG. 9, four liquid crystal lenses are formed in the liquid crystal layer 102. As described above, the liquid crystal lens has a concentric liquid crystal alignment pattern in which the optical axis derived from the liquid crystal compound continuously rotates in the one direction.

Next, as shown on the right side in the middle of FIG. 9, each of the regions of the liquid crystal layer 102 having the liquid crystal alignment pattern is cut out by cutting.

The cutting method is not particularly limited, and a known cutting method in the related art, such as dicing, laser processing, or punching, can be used.

As described above, as shown on the right side in the lower part of FIG. 9, the first laminate 14 in which the optical functional layer 12 is laminated on the support 18 is obtained. That is, in this example, the support 18 includes a substrate and an alignment film. Since the first laminate 14 is cut, the edge surface of the support 18 and the edge surface of the optical functional layer 12 are flush with each other.

Next, an edge surface covering layer 20 is formed on the edge surface of each of the obtained first laminates 14. The method of forming the edge surface covering layer 20 is as described above.

As described above, the optical laminate 10 according to the embodiment of the present invention is obtained.

In the example shown in FIG. 9, the region including four liquid crystal alignment patterns is formed in one liquid crystal layer 102, but the present invention is not limited to this. One to three regions including the liquid crystal alignment patterns may be formed in the liquid crystal layer 102, or five or more regions including the liquid crystal alignment patterns may be formed in the liquid crystal layer 102. In addition, the disposition of the liquid crystal alignment patterns in the liquid crystal layer 102 is not limited to the example shown in the drawing.

In addition, in the above-described example, the liquid crystal layer 102 is cut together with the substrate 104 and the alignment film 105 after the alignment film 105 is formed on the substrate 104 and the liquid crystal layer 102 is formed, but the present invention is not limited to this. The alignment film 105 may be formed on the substrate 104, the liquid crystal layer 102 may be formed, the liquid crystal layer 102 may be peeled off from the substrate 104 and bonded to another support, and the liquid crystal layer may be cut together with the other support to produce the first laminate 14. In this case, only the liquid crystal layer 102 may be transferred to another support, or the alignment film may be peeled off from the substrate 104 together with the liquid crystal layer 102, and the laminate of the alignment film 105 and the liquid crystal layer 102 may be transferred to another support.

In addition, in a case where the liquid crystal layer 102 is transferred to another support, an optically clear adhesive (OCA) or the like may be used as necessary.

In addition, in the example shown in FIG. 9, the concentric liquid crystal alignment pattern is formed in the liquid crystal layer 102, but the present invention is not limited to this. In the liquid crystal layer 102, a plurality of liquid crystal alignment patterns in which the direction in which the orientation of the optical axis 40A of the liquid crystal compound 40 changes rotationally is one direction as shown in FIG. 7 may be formed.

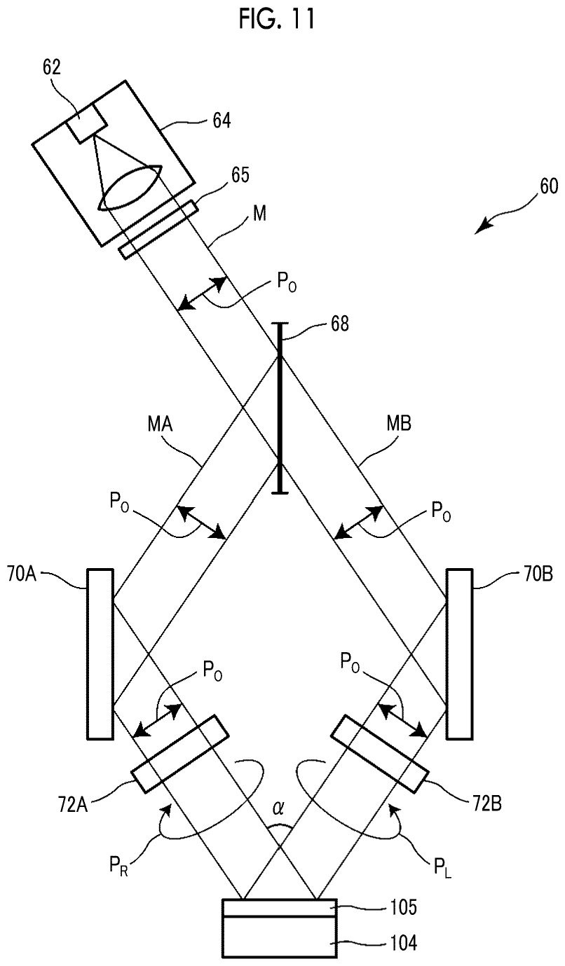

FIG. 11 conceptually shows an example of an exposure device for exposing an alignment film for forming an optical functional layer having a liquid crystal alignment pattern as shown in FIG. 7.

An exposure device 60 shown in FIG. 11 comprises a light source 64 comprising a laser 62, an λ/2 plate 65 that changes a polarization direction of laser light M emitted from the laser 62, a beam splitter 68 that splits the laser light M emitted from the laser 62 into each of two beams MA and MB, mirrors 70A and 70B that are respectively disposed on optical paths of the split two beams MA and MB, and λ/4 plates 72A and 72B.

The light source 64 emits linearly polarized light P₀. The λ/4 plate 72A converts the linearly polarized light P₀ (ray MA) into dextrorotatory circularly polarized light P_{R}, and the λ/4 plate 72B converts the linearly polarized light P₀ (ray MB) into levorotatory circularly polarized light P_{L}, respectively.

A substrate 104 having an alignment film 105 (a coating film serving as an alignment film) before forming an alignment pattern is disposed at an exposed portion, the two rays MA and MB intersect and interfere with each other on the alignment film 105, and the alignment film 105 is irradiated with and exposed to the interference light.

Due to the interference in this case, the polarization state of light with which the alignment film 105 is irradiated periodically changes according to interference fringes. As a result, an alignment film (hereinafter, also referred to as “patterned alignment film”) having an alignment pattern in which the orientation state changes periodically is obtained.

In the exposure device 60, the period of the alignment pattern can be adjusted by changing an intersecting angle α between the two rays MA and MB. That is, by adjusting the intersecting angle α in the exposure device 60, in the alignment pattern in which the optical axis 40A derived from the liquid crystal compound 40 continuously rotates in the one in-plane direction, the length of the single period over which the optical axis 40A rotates by 180° in the one direction in which the optical axis 40A rotates can be adjusted.

By forming a liquid crystal layer on the alignment film 105 having an alignment pattern in which the orientation state periodically changes, an optically anisotropic layer having a liquid crystal alignment pattern in which the optical axis 40A derived from the liquid crystal compound 40 continuously rotates in the one direction can be formed.

In addition, by rotating the optical axes of the λ/4 plates 72A and 72B by 90°, respectively, a rotation direction of the optical axis 40A can be reversed.

Hereinabove, the optical laminate according to the embodiment of the present invention has been described. However, the present invention is not limited thereto, and various improvements and modifications can be made within a range not departing from the scope of the present invention.

### EXAMPLES

Hereinafter, the embodiment of the present invention will be described in more detail with reference to specific Examples of the present invention.

### Example 1

A glass substrate having a size of 150 mm×150 mm and a thickness of 0.5 mm was used as a substrate, and the following coating liquid for forming an alignment film was applied by spin coating. The substrate on which the coating film of the coating liquid for forming an alignment film was formed was dried on a hot plate at 60° C. for 60 seconds to form an alignment film.

Coating liquid for forming alignment film

| | |
|---|---|
| Material A for photo-alignment | 1.00 part by mass |
| Water | 16.00 parts by mass |
| Butoxyethanol | 42.00 parts by mass |
| Propylene glycol monomethyl ether | 42.00 parts by mass |

-Material A for photo-alignment-

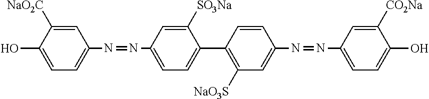

### (Exposure of Alignment Film)

The formed alignment film was exposed using a beam combiner (exposure device) of Example 1 of WO2022/016539A to form an alignment film P-1 having an alignment pattern capable of forming a liquid crystal alignment pattern having a one-directional property in a radial shape as shown in FIG. 5, in which the optical axis 40A of the liquid crystal compound 40 changes while continuously rotating.

The single period A in the alignment pattern of the alignment film changed in a plane, and the minimum value thereof was 1 μm. The single period A of the alignment pattern was adjusted based on the focal length of a convex lens used as the optical element.

A light source that emits laser light having a wavelength of 355 nm was used as the light source. The exposure amount of the interference light was 1000 mJ/cm².

In the present example, the alignment film was exposed at four locations. That is, four regions having the alignment pattern were formed in the alignment film.

The thermal expansion coefficient of the support including the glass substrate and the alignment film was 3×10⁻⁶/° C.

### (Formation of Liquid Crystal Layer)

As a liquid crystal composition forming a liquid crystal layer A-1 including a region serving as an optical functional layer, the following liquid crystal composition A-1 was prepared.

Liquid crystal composition A-1

| | |
|---|---|
| Liquid crystal compound L-1 | 100.00 parts by mass |
| Polymerization initiator (manufactured by BASF, Irgacure OXE01) mass | 1.00 parts by mass |
| Leveling agent T-1 | 0.08 parts by mass |
| Methyl ethyl ketone | 1,050.00 parts by mass |

Liquid crystal compound L-1 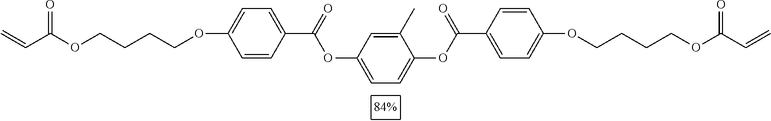 [SMILES: C=CC(=O)OCCCCOc1ccc(C(=O)Oc2ccc(OC(=O)c3ccc(OCCCCOC(=O)C=C)cc3)c(C)c2)cc1] 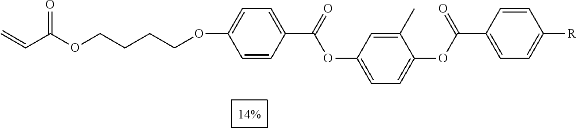 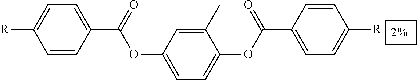 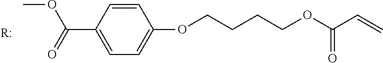
Leveling agent T-1

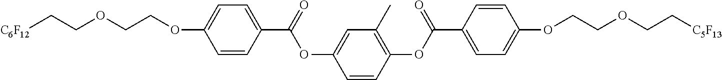

The liquid crystal composition A-1 was applied to the alignment film P-1 to form a coating film, and the coating film was heated using a hot plate at 80° C. Next, the coating film was irradiated with ultraviolet light having a wavelength of 365 nm at an irradiation dose of 300 mJ/cm² using a high pressure mercury lamp in a nitrogen atmosphere. As a result, the alignment of the liquid crystal compound was immobilized. As a result, four regions having a concentric liquid crystal alignment pattern were formed in the liquid crystal layer A-1.

In this manner, a laminate in which the alignment film P-1 and the liquid crystal layer A-1 were laminated in this order on the glass substrate was obtained.

Next, each of regions including the liquid crystal alignment pattern was cut out from the laminate by dicing to have a size of 4 cm×4 cm, thereby obtaining a first laminate. The center of the first laminate to be cut out substantially matched the center of the liquid crystal alignment pattern.

As a coating liquid of an acrylic resin serving as an edge surface covering layer, A-DPH manufactured by Shin-Nakamura Chemical Co., Ltd., KBM-5103 (silane coupling agent) manufactured by Shin-Etsu Silicone Co., Ltd., a polymerization initiator (Irg184 manufactured by BASF SE), and a solvent (methyl ethyl ketone (MEK)) were mixed to prepare the coating liquid. The obtained side surface of the first laminate was coated with the coating liquid of the acrylic resin using a dispenser (SDP520 manufactured by San-Ai-tek Inc.) including a precision position adjustment mechanism (AXA200 manufactured by San-Ai-tek Inc.), and heated (100° C., 1 minute) and irradiated with UV (365 nm, 300 mJ/cm²) to form an edge surface covering layer. The edge surface covering layer had a thickness d of 1 μm and was not formed on the main surface of the first laminate. That is, the edge surface covering layer did not have a ramp portion. In addition, when viewed from a direction perpendicular to the main surface of the first laminate, the edge surface covering layer was provided at both end portions of each side of the main surface of the first laminate, and was formed such that the length from the corner portion was 15% of the length L of the side. That is, the total length of the edge surface covering layer on each side of the main surface of the first laminate was 30% of the length of the side. In addition, the length of the edge surface covering layer in the thickness direction was 50% of the thickness of the first laminate. As described above, an optical laminate was produced. In each of Examples and Comparative Examples below, the coating range of the edge surface covering layer, the width of the ramp portion on the main surface, and the like were changed by adjusting the discharge position of the dispenser using a position adjustment mechanism. In addition, the thickness of the edge surface covering layer was changed by the discharge amount of the dispenser.

The peeling strength of the edge surface covering layer from the support and the optical functional layer was evaluated by attaching a cellophane tape (registered trademark) having a peeling strength of 4 N/cm to the edge surface covering layer and pulling the tape in a direction of 90° with a peeling tester to determine whether or not the edge surface covering layer was reflected on the tape. The peeling strength was 4 N/cm or more.

### Example 2

An optical laminate was produced in the same manner as in Example 1, except that each of the lengths of the edge surface covering layer from the corner portion of the main surface of the first laminate when viewed from a direction perpendicular to the main surface of the first laminate was formed to be 25% of the length L of the side.

### Example 3

An optical laminate was produced in the same manner as in Example 1, except that the edge surface covering layer was formed on the entire region of each side of the main surface of the first laminate when viewed from a direction perpendicular to the main surface of the first laminate.

### Example 4

An optical laminate was produced in the same manner as in Example 2, except that the thickness d of the edge surface covering layer was set to 0.5 μm.

### Example 5

An optical laminate was produced in the same manner as in Example 2, except that the edge surface covering layer had a ramp portion formed on the main surface on the optical functional layer side.

The width w of the ramp portion was set to 0.1 mm, and the height h was set to 1 μm.

### Example 6

An optical laminate was produced in the same manner as in Example 2, except that the edge surface covering layer had a ramp portion formed on both main surfaces of the first laminate.

The width w of the ramp portion was set to 0.1 mm, and the height h was set to 1 μm.

### Example 7

An optical laminate was produced in the same manner as in Example 5, except that the amount of the silane coupling agent added was reduced so that the peeling strength of the edge surface covering layer with respect to the support and the optical functional layer was less than 4 N/cm.

### Example 8

An optical laminate was produced in the same manner as in Example 6, except that the material for forming the edge surface covering layer was changed to an epoxy resin (EPICLON manufactured by DIC Corporation).

### Example 9

An optical laminate was produced in the same manner as in Example 6, except that the material for forming the edge surface covering layer was changed to a silicone resin (X-88-2003A manufactured by Shin-Etsu Silicone Co., Ltd.). In the present example, the edge surface covering layer was cured by being placed in an atmosphere of 25° C. for 30 minutes without heating and UV irradiation.

### Example 10

An optical laminate was produced in the same manner as in Example 5, except that a light absorbing material was added to the coating liquid for forming the edge surface covering layer.

As the light absorbing material, a black colorant (manufactured by FUJIFILM Wako Pure Chemical Corporation) was used. The proportion of the light absorbing material to the coating liquid was 0.02% by mass.

### Example 11

An optical laminate was produced in the same manner as in Example 2, except that an aluminum film was formed as the edge surface covering layer by vapor deposition, and the thickness d was set to 10 nm. The position where the edge surface covering layer was formed was adjusted by masking with a polyimide tape.

### Example 12

An optical laminate was produced in the same manner as in Example 11, except that the thickness d of the edge surface covering layer was set to 5 nm.

### Example 13

An optical laminate was produced in the same manner as in Example 5, except that a silicon substrate having a size of 150 mm×150 mm and a thickness of 0.5 mm was used as the substrate, and a laminate in which the optical functional layer was laminated on the silicon substrate was cut into 40 mm×40 mm to produce a first laminate. The thermal expansion coefficient of the support was 4×10⁻⁶/° C.

### Example 14

An optical laminate was produced in the same manner as in Example 5, except that a quartz substrate having a size of 150 mm×150 mm and a thickness of 0.5 mm was used as the substrate, and a laminate in which the optical functional layer was laminated on the quartz substrate was cut into 40 mm×40 mm to produce a first laminate. The thermal expansion coefficient of the support was 5×10⁻⁷/° C.

### Comparative Example 1

An optical laminate was produced in the same manner as in Example 1, except that the edge surface covering layer was not formed.

### Comparative Example 2

An optical laminate was produced in the same manner as in Example 1, except that the edge surface covering layer was formed such that each of the lengths from the corner portion of the main surface of the first laminate was 5% of the length L of the side when viewed from a direction perpendicular to the main surface of the first laminate.

### [Evaluation A]

The produced optical laminates of Examples and Comparative Examples were stored in a room at normal temperature (25° C.) for 1 day, and the side surface of the optical laminate was observed with a microscope to determine whether or not the optical functional layer was peeled off from the support. A case where no peeling was observed was evaluated as A, and a case where peeling was observed was evaluated as C.

### [Evaluation B]

The produced optical laminates of Examples and Comparative Examples were stored in a low-temperature dryer set at 50° C. for 1 day and 7 days, and the side surface of the optical laminate was observed with a microscope to determine whether or not the optical functional layer was peeled off from the support. A case where no peeling was observed after 7 days was evaluated as A, a case where no peeling was observed after 1 day and peeling was observed after 7 days was evaluated as B, and a case where peeling was observed after 1 day was evaluated as C.

The results are shown in Table 1. In Table 1, the peeling strength of 4 N/cm or more is evaluated as A, and the peeling strength of less than 4 N/cm is evaluated as B.

TABLE 1

| | Edge surface covering layer | | | | | | | | Substrate | | | |
|---|---|---|---|---|---|---|---|---|---|---|---|---|
| | | | | Ratio of | Ramp portion | | | | | Thermal | | |
| | | | | length from | | Width | Height | | | expansion | | |
| | Forming | Thickness | | corner | Presence or | w | h | Peeling | Material | coefficient | Evaluation | Evaluation |
| | material | d | | portion | absence | mm | μm | strength | quality | (1/° C.) | A | B |
| Example 1 | Acrylic resin | 1 | μm | Each 15% | Absent | — | — | A | Glass | 3 × 10⁻⁶ | A | C |
| Example 2 | Acrylic resin | 1 | μm | Each 25% | Absent | — | — | A | Glass | 3 × 10⁻⁶ | A | B |
| Example 3 | Acrylic resin | 1 | μm | 100% | Absent | — | — | A | Glass | 3 × 10⁻⁶ | A | B |
| Example 4 | Acrylic resin | 0.5 | μm | Each 25% | Absent | — | — | A | Glass | 3 × 10⁻⁶ | A | C |
| Example 5 | Acrylic resin | 1 | μm | Each 25% | Single-sided | 0.1 | 1 | A | Glass | 3 × 10⁻⁶ | A | A |
| Example 6 | Acrylic resin | 1 | μm | Each 25% | Both-sided | 0.1 | 1 | A | Glass | 3 × 10⁻⁶ | A | A |
| Example 7 | Acrylic resin | 1 | μm | Each 25% | Single-sided | 0.1 | 1 | B | Glass | 3 × 10⁻⁶ | A | B |
| Example 8 | Epoxy resin | 1 | μm | Each 25% | Both-sided | 0.1 | 1 | A | Glass | 3 × 10⁻⁶ | A | A |
| Example 9 | Silicon resin | 1 | μm | Each 25% | Both-sided | 0.1 | 1 | A | Glass | 3 × 10⁻⁶ | A | A |
| Example 10 | Acrylic resin + | 1 | μm | Each 25% | Single-sided | 0.1 | 1 | A | Glass | 3 × 10⁻⁶ | A | A |
| | light absorbing | | | | | | | | | | | |
| | material | | | | | | | | | | | |
| Example 11 | Inorganic film | 10 | nm | Each 25% | Absent | — | — | A | Glass | 3 × 10⁻⁶ | A | B |
| Example 12 | Inorganic film | 5 | nm | Each 25% | Absent | — | — | A | Glass | 3 × 10⁻⁶ | A | C |
| Example 13 | Acrylic resin | 1 | μm | Each 25% | Single-sided | 0.1 | 1 | A | Silicon | 4 × 10⁻⁶ | A | A |
| Example 14 | Acrylic resin | 1 | μm | Each 25% | Single-sided | 0.1 | 1 | A | Quartz | 5 × 10⁻⁷ | A | A |
| Comparative | None | — | | — | — | — | — | — | Glass | 3 × 10⁻⁶ | C | C |
| Example 1 | | | | | | | | | | | | |
| Comparative | Acrylic resin | 1 | μm | Each 5% | Absent | — | — | A | Glass | 3 × 10⁻⁶ | C | C |

Example 2

From Table 1, it was found that the Examples of the present invention could suppress the peeling of the optical functional layer from the support as compared with the Comparative Examples.

In addition, from the comparison of Examples 1 to 3, it was found that the total length of the edge surface covering layer when viewed from a direction perpendicular to the main surface of the first laminate was preferably 50% or more of the length of each side of the main surface of the first laminate.

From the comparison of Example 2 and Example 4, it was found that the thickness d of the edge surface covering layer in a case where the edge surface covering layer was an organic material was preferably 1 μm or more.

From the comparison of Examples 2, 5, and 6, it was found that the edge surface covering layer preferably had a ramp portion formed on the main surface of the first laminate.

From the comparison of Example 5 and Example 7, it was found that the peeling strength of the edge surface covering layer from the support and the optical functional layer was preferably 4 N/cm or more.

In a case where the optical laminate of Example 10 was irradiated with light from a light source, the amount of light (primary diffracted light) that was appropriately diffracted and transmitted through the optical laminate and light (zero-order light and −1-order light) that was not appropriately diffracted were measured with an optical power meter, and it was confirmed that unnecessary noise light (zero-order light and −1-order light) could be suppressed by including a light absorbing material in the edge surface covering layer.

From the comparison of Example 11 and Example 12, it was found that the thickness d of the edge surface covering layer in a case where the edge surface covering layer was an inorganic material was preferably 10 nm or more.

From the above results, the effects of the present invention are clear.

### EXPLANATION OF REFERENCES

10, 10b, 10c: optical laminate
   12: optical functional layer
   14: first laminate
   18: support
   20, 20b, 20c: edge surface covering layer
   40: liquid crystal compound
   40A: optical axis
   60, 80: exposure device
   62, 82: laser
   64, 84: light source
   65: λ/2 plate
   68: beam splitter
   70A, 70B: mirror
   72A, 72B: λ/4 plate
   86, 94: polarization beam splitter
   90A, 90B: mirror
   92: lens
   96: λ/4 plate
   102: liquid crystal layer
   104: substrate
   105: alignment film

What is claimed is:

1. An optical laminate comprising: a first laminate including a support and an optical functional layer that is laminated on the support and is formed of a liquid crystal composition containing a liquid crystal compound,
wherein a thermal expansion coefficient of the support is less than 1×10⁻⁵/° C.,
the optical functional layer has a liquid crystal alignment pattern in which an orientation of an optical axis derived from the liquid crystal compound changes while the orientation continuously rotates along at least one in-plane direction,
an edge surface of the support and an edge surface of the optical functional layer in the first laminate are flush with each other,
the optical laminate has an edge surface covering layer that covers a region corresponding to an interface between the support and the optical functional layer on the edge surface of the first laminate, and
when viewed from a direction perpendicular to a main surface of the first laminate, the edge surface covering layer covers a portion corresponding to 10% or more of a length of each side from each corner portion of the main surface of the first laminate.

2. The optical laminate according to claim 1, wherein when viewed from the direction perpendicular to the main surface of the first laminate, the edge surface covering layer covers a portion corresponding to 50% or more of a length of each side of the main surface of the first laminate.

3. The optical laminate according to claim 1, wherein the edge surface covering layer is an organic material, and a thickness of the edge surface covering layer in a direction perpendicular to the edge surface of the first laminate is 1 μm to 1 mm.

4. The optical laminate according to claim 1, wherein the edge surface covering layer is an inorganic material, and a thickness of the edge surface covering layer in a direction perpendicular to the edge surface of the first laminate is 10 nm to 500 nm.

5. The optical laminate according to claim 1, wherein the edge surface covering layer covers the edge surface from a part of at least one main surface of the first laminate.

6. The optical laminate according to claim 5, wherein the edge surface covering layer covers the edge surface from a part of the main surface of the first laminate on an optical functional layer side.

7. The optical laminate according to claim 5, wherein the edge surface covering layer covers the edge surface from a part of main surfaces of the first laminate on both sides.

8. The optical laminate according to claim 5, wherein a width of a ramp portion of the edge surface covering layer, which is formed on the main surface of the first laminate, from the edge surface is 0.01 mm or more.

9. The optical laminate according to claim 5, wherein the edge surface covering layer is an organic material, and a height of a ramp portion, which is formed on the main surface of the first laminate, in a direction perpendicular to the main surface is 1 μm to 1 mm.

10. The optical laminate according to claim 5, wherein the edge surface covering layer is an inorganic material, and a height of a ramp portion, which is formed on the main surface of the first laminate, in a direction perpendicular to the main surface is 10 nm to 500 nm.

11. The optical laminate according to claim 1, wherein a peeling strength of the edge surface covering layer with respect to the support and the optical functional layer is 4 N/cm or more.

12. The optical laminate according to claim 1, wherein a material of the support includes any one of glass, quartz, or silicon.

13. The optical laminate according to claim 1, wherein the edge surface covering layer is an organic material, and includes any one of an acrylic resin, an epoxy resin, or a silicone resin.

14. The optical laminate according to claim 1, wherein the edge surface covering layer is an organic material, and includes a light absorbing material.

15. The optical laminate according to claim 1, wherein the optical functional layer is formed of a liquid crystal composition containing a polymerizable liquid crystal compound, and is a cured film obtained by polymerizing the polymerizable liquid crystal compound.

16. The optical laminate according to claim 1, wherein the first laminate is obtained by cutting.

17. The optical laminate according to claim 2, wherein the edge surface covering layer is an organic material, and a thickness of the edge surface covering layer in a direction perpendicular to the edge surface of the first laminate is 1 μm to 1 mm.

18. The optical laminate according to claim 2, wherein the edge surface covering layer is an inorganic material, and a thickness of the edge surface covering layer in a direction perpendicular to the edge surface of the first laminate is 10 nm to 500 nm.

19. The optical laminate according to claim 6, wherein a width of a ramp portion of the edge surface covering layer, which is formed on the main surface of the first laminate, from the edge surface is 0.01 mm or more.

20. The optical laminate according to claim 6, wherein the edge surface covering layer is an organic material, and a height of a ramp portion, which is formed on the main surface of the first laminate, in a direction perpendicular to the main surface is 1 μm to 1 mm.
